(19) United States
(12) Patent Application Publication
(10) Pub. No.: US 2010/0118698 A1
(43) Pub. Date: May 13, 2010

(54) RADIO COMMUNICATION METHOD, RADIO COMMUNICATION SYSTEM, RADIO COMMUNICATION DEVICE, AND CONGESTION CONTROL METHOD

(75) Inventors: Michiru Yokobori, Kanagawa (JP); Tetsuya Kawakami, Kanagawa (JP); Kazuhiko Miyamoto, Tokyo (JP); Yoshihiro Suzuki, Kanagawa (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/529,205

(22) PCT Filed: Jul. 28, 2007
(86) PCT No.: PCT/JP2008/002007

§ 371 Date: Aug. 31, 2009

(30) Foreign Application Priority Data
Aug. 1, 2007 (JP) 2007-200956
Aug. 1, 2007 (JP) 2007-201019
Aug. 2, 2007 (JP) 2007-202206
Aug. 2, 2007 (JP) 2007-202222

(51) Int. Cl. H04W 28/08; H04W 40/00

(52) U.S. Cl. 370/230; 370/328

(57) ABSTRACT

Disclosed is a technique to prevent a collision in a state that radio communication devices are congested. According to the technique, in the state that the radio communication devices are congested, one of the radio communication devices becomes a representative node and transmits a representative node advertisement message. When the representative node has received a data packet after transmission of the representative node advertisement message, it transmits a response confirmation message. When a radio communication device, which was not decided as the representative node, has become a normal node and received the representative node advertisement message, it transmits a data packet. Then, when receiving a confirmation message after transmission of the data packet, the radio communication device stops data packet transmission during the next active period.

### TECHNICAL FIELD

The present invention relates to a radio communication method, a radio communication system, and a radio communication device, in which any period within a superframe of a constant cycle is defined as an active period and the rest is defined as a sleep period, and the active period is divided into plural time slots to enable each of plural radio communication devices to perform time-division two-way communication using each time slot.

The present invention particularly relates to low-power consumption media access control (MAC) used in the case of two-way data exchange between radio communication devices (nodes) that move while transmitting data periodically.

The present invention also relates to a congestion control method in a radio communication system, in which a given period within a superframe of a constant cycle is defined as an active period and the rest is defined as a sleep period, and the active period is divided into plural time slots to enable each of plural radio communication devices to perform time-division two-way communication using each time slot. This invention further relates to a radio communication system and a radio communication device.

Further, the present invention specifically relates to control of communication congestion caused when radio communication devices (nodes) exist densely in a radio communication range, and to media access control for reducing the power consumption of a battery in a radio communication node while avoiding communication conflicts.

### BACKGROUND ART

Power consumption reduction of radio hardware in radio devices is a key requirement. Radio communication systems include, especially as application examples requiring a power saving mechanism, an active electronic tag system, a sensor network system, etc. Since sensor nodes and the like in these active electronic tag and sensor network systems are required to have portability and ease/flexibility of installation, they are normally battery-powered nodes with built-in small batteries.

Applications to these active electronic tag system, sensor network system, etc. feature low traffic. In an active electronic tag system, small data including ID (identification information) of each active electronic tag itself is usually transmitted. Further, in a sensor network system using ZigBee (registered trademark) as shown in Non-Patent Document 1, sensor nodes often perform intermittent transmission of small sensing data.

In ZigBee (registered trademark) as shown in Non-Patent Document 1 cited below as a short distance wireless communication standard, a beacon signal is used as a sync signal to define a given period within a constant cycle as an active period (superframe period) and the rest as a sleep period, and the active period is divided into plural time slots to enable each of plural radio communication devices to perform time-division two-way communication using each time slot. Further, Patent Document 1 cited below as another conventional example proposes a method of providing a reception interval immediately after a beacon signal transmitted by each radio communication node and setting the rest as a reserved period as an adhoc communication system, in which a large number of radio communication nodes perform asynchronous radio communication directly without going through another node such as a base station or a control station. Further, Patent Document 2 cited below proposes a method of deciding a time slot for transmitting a beacon signal when a superframe of a constant cycle is set using, as a sync signal, a beacon signal to be transmitted by each radio communication node.

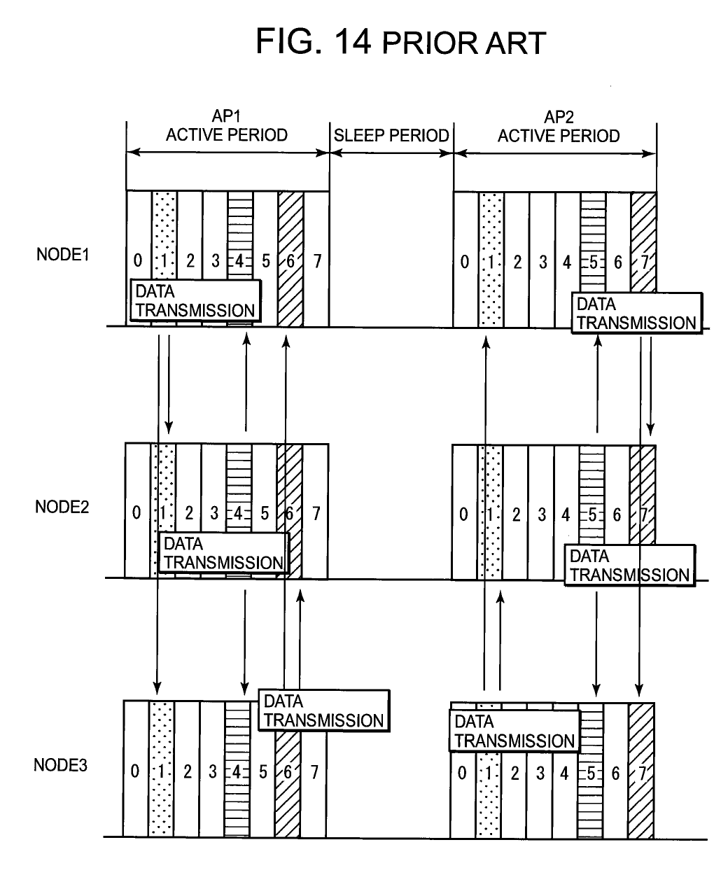

In Non-Patent Document 1 enabling low-power consumption radio communication two techniques are defined as means for avoiding the occurrence of a collision. The following illustrates one of the techniques. FIG. 14 shows a procedure for detecting an empty time slot by CSMA/CA (Carrier Sense Multiple Access/Collision Avoidance) to perform transmission. In CSMA/CA, processing for confirming the availability of radio channels is called CCA (Clear Channel Assessment). In the technique shown in FIG. 14, this CCA is performed in each time slot, and when any node being performing radio communication is detected, transmission is stopped, thereby making it possible to avoid the occurrence of a collision. In the first active period AP1 (time slots=0, 1, . . . , 7), node 1 transmits data to nodes 2 and 3 in time slot=1, node 2 transmits data to nodes 1 and 3 in time slot=4, and node 3 transmits data to nodes 1 and 2 in time slot=6. In the following active period AP2 (time slots=0, 1, . . . , 7), node 3 transmits data to nodes 1 and 2 in time slot=1, node 2 transmits data to nodes 1 and 3 in time slot=5, and node 1 transmits data to nodes 1 and 3 in time slot=7.

The second technique is to ensure the avoidance of occurrence of a collision in such a manner that a coordinator allocates a time slot to each node. Non-Patent Document 1 makes it possible to have a network structure in which each node is placed under the control of the coordinator responsible for building and maintenance of a network and specification of transmission timing of each node. In this case, since each node transmits data at timing instructed by the coordinator, no collision occurs.

Further, ZigBee (registered trademark) confirms the arrival of data having an ACK function. If no ACK can be received, a data packet is retransmitted to improve the reliability of data packet arrival. When the data packet is unicast, an ACK is transmitted without specifying the destination immediately after completion of data reception at the data packet destination. Only a sequence number of received data is included in the ACK to reduce the time to create the ACK message. These two features reduce the time until completion of confirming the arrival of data. In the case of broadcast, a node receives broadcast data transferred by another node and determines that it is an ACK for a broadcast packet transmitted by its own node to enable confirmation of the arrival of data. This is called a passive ACK. Use of the passive ACK eliminates the time required to create an ACK message, and hence reduces the time until completion of confirmation of the arrival of data.

Patent Document 1 discloses a technique for recoding the timings of data transmission of peripheral nodes and deciding the timing of data transmission of its own node while avoiding a collision between data transmission timings. This technique is a system for data exchange between nodes that transmit data at a constant cycle (superframe), where a node performs a scan within the superframe before starting data transmission to decide the timing of data transmission of its own node while avoiding timings during which peripheral nodes transmit data. After that, the node continues data transmission at the timing decided.

Patent Document 2 as still another conventional example proposes a method of providing a reception interval immediately after a beacon signal transmitted by each radio communication node and setting the rest as a reserved period as an adhoc communication system, in which a large number of radio communication nodes perform asynchronous radio communication directly without going through another node such as a base station or a control station. Further, Patent Document 1 discloses a method of autonomously advertising use of its own slot to an empty slot in a method of allocating each time slot to a node. According to this method, each node scans the time of a given time slot, and determines a time slot to be used and empty time slots to construct a table in order to use the empty time slots sequentially, thereby enabling efficient use of time slots.

For example, if there is a node that uses no time slot any more, the time slot is scanned as an empty time slot to be used by another node. When radio communication nodes using such a method exist densely in a radio communication range, if the number of nodes exceeds the number of time slots, no time slot may be available and some nodes may not be able to communicate. In such a congestion state, it is desirable that a node that has finished transmission should stop communication for a certain period of time to release its time slot so that another node can use it. In this case, considering the radio communication characteristics, it is desirable that the node should stop transmission after confirming that a frame transmitted by itself has been delivered to a destination. In such a case, it is considered that a receipt response (ACK, NACK) from a node that has received the frame is confirmed.

When a large number of radio communication nodes exist densely in a radio communication range, it is considered that communication congestion occurs especially in such a case that nodes using the same frequency communicate in a time-sharing manner. Therefore, it is important to provide access control for avoidance of communication conflicts. Further, in the case of nodes, such as active electronic tags, which output their own information periodically using internal batteries as power sources, collisions are controlled by shifting transmission timings back and forth at random in a constant cycle. However, if the node density in the radio communication range is high, collisions could disable communication. In this case, the number of nodes to communicate is reduced until the congestion state is avoided to enable continuous communication while avoiding temporary congestion. In such a case, it is important to determine which node should stop transmission.

However, if the nodes are of a type that transmits only their own information like active electronic tags, it is difficult to determine the state of congestion, and there is no choice but to wait until the congestion state is physically avoided due to the movement of the nodes or the like. Further, if the nodes are of a type that receives a command from a reader like passive tags without internal batteries, the reader as a specific node manages the state and performs access control on each tag to enable control during congestion. This is realized in such a manner that the tags perform transmission by rotation after each node confirms that the reader has received information transmitted by the node. Thus, a method of avoiding congestion is employed, in which a node transmitting information is notified during congestion that the information has been received to cause the node to stop communication in order to reduce the number of nodes to communicate simultaneously. The acknowledgement of information can improve the reliability of information transmission. Further, since nodes stop transmission during congestion in order from a node that has confirmed that information was received, it is considered that more efficient information transmission is possible compared to the method in which a node that has recognized congestion just stops transmission for a certain period of time.

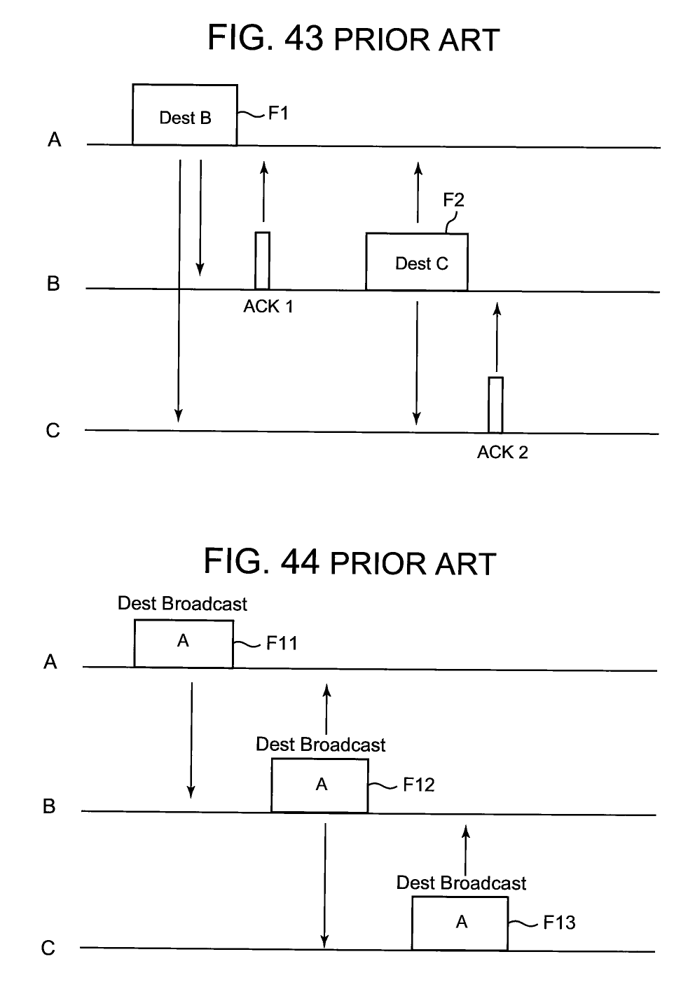

Conventional operations of sending receipt responses will be described with reference to FIG. 43 and FIG. 44. FIG. 43 shows an operation when three active-type radio communication nodes A, B, and C with internal batteries transmit and receive unicast frames having destination nodes to which they are destined. The nodes are located in communicable distances from one another. Although frame F1 (Dest B) destined to node B and output by node A can be received by nodes B and C, node B receives it as a result of filtering of the address (Dest B) and transmits an acknowledgement (ACK 1) indicative of the reception. Further, as for frame 2 (Dest C) destined to node C and output by node B, an acknowledgement is made by ACK 2 from node C. Here, transmission of a new acknowledgement frame during congestion increases the number of frames necessary to be transmitted, and could increase congestion as well. Therefore, in Non-Patent Document 1 or the like, an ACK frame is immediately returned in a very short frame unlike data frames F1 and F2. Such a method enables receipt notification to nodes A and B that sent frames F1 and F2 without increasing congestion and adding detailed information for specifying a frame in which ACK is being returned.

However, in such a unicast case that a destination is thus decided, since the number of nodes to respond is one, nodes B and C that have received frames F1 and F2, respectively, can immediately return ACK frames (ACK1, ACK2). However, as for frames to be transmitted to an indefinite number of nodes in the case of broadcast or the like, if plural nodes return ACKs upon reception, an ACK collision occurs and this makes it difficult to confirm reception. Therefore, in Patent Document 2 or the like, such a passive ACK method that confirms responses in response to a returned frame transmitted by itself as shown in FIG. 43 where received frames F11, F12, and F13 are transferred.

Non-Patent Document 1: IEEE802.15.4

Patent Document 1: Japanese Patent Application Publication No. 2006-121332 (Abstract)

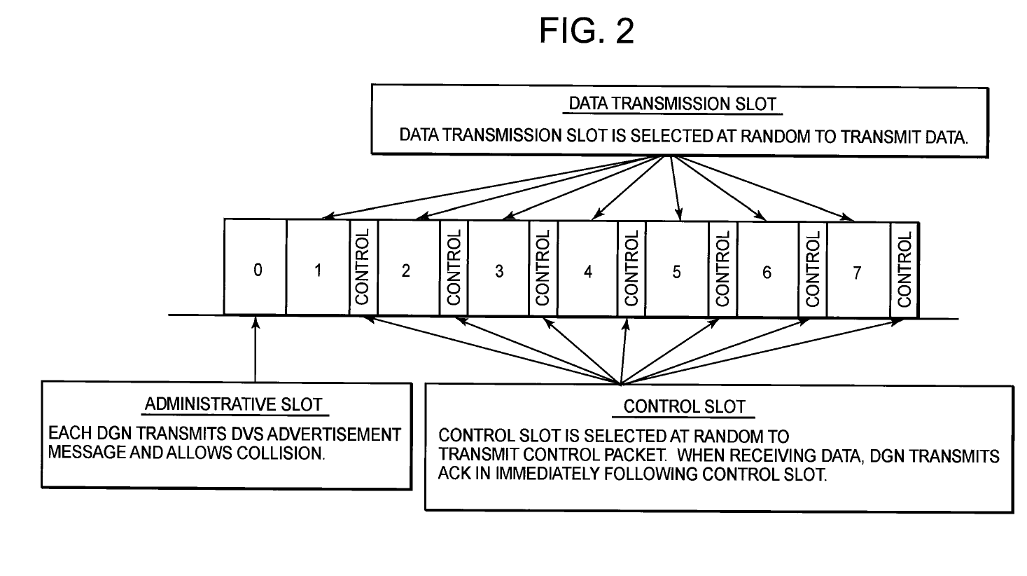

Patent Document 2: Japanese Patent Application Publication No. 2004-228926 (FIG. 2)

### DISCLOSURE OF THE INVENTION

### Problems to be Solved by First and Second Inventions

However, the above-mentioned techniques are not always applicable to a case where nodes are congested in a communication system in which moving communication nodes carry out two-way data exchange. The first technique in Non-Patent Document 1 enables transmission by distributed control because the transmission timing is selected depending on the randomness of each node. However, if the number of nodes existing in a mutual propagation coverage is twice as many as the number of time slots in one active period, communication may be totally disabled. If sets of two nodes that have performed CCA at the same timing in the same time slot exist as many as the number of time slots, nodes communicable in this active period are unable to exist. This means that, as the number of nodes congested in the same radio propagation coverage increases, the chances to make communication impossible increase.

The second technique in Non-Patent Document 1 guarantees transmission paths, so that nodes allocated time slots from a coordinator can transmit data reliably. However, this guaranteed feature is limited to a case where the network topology is of a star type with the coordinator as its center. In a communication system in which node position cannot be fixed because nodes move, a node having a specific function as the coordinator cannot be always held in close proximity to other nodes. Further, even if the coordinator always exists close to mobile nodes, it is very difficult to build a star topology in the communication system in which nodes move. The problem is that data transmission cannot be started unless a collision in control data exchange for forming a star topology can be avoided.

Further, a time slot has to be allocated from the coordinator each time data is transmitted. This also poses a problem that data transmission cannot be started unless a collision in data exchange for causing a mobile node to be allocated a time slot can be avoided.

If nodes that move while transmitting data periodically are congested, use of the ACK function of ZigBee (registered trademark) is made difficult. In the case of unicast, a node as a destination described in a data packet transmits an ACK to confirm the arrival of data. However, in a system having no destination information in a data packet, such as an electronic tag system, since a node to transmit the ACK cannot be specified from plural nodes that have received the data packet, the ACK cannot be transmitted. If all the nodes that have received the data packet transmit the ACK without specifying a node to transmit the ACK, a transmission collision occurs. In the case of broadcast, a passive ACK needs to be received from other nodes. However, in a system, such as the electronic tag system, in which no data packet is transferred, reception of the passive ACK cannot be expected. Therefore, in such a state that mobile nodes are congested, each node cannot confirm the arrival of data transmitted by itself using the ACK function of ZigBee (registered trademark).

In the technique of Patent Document 1, as the number of nodes to transmit data continues to increase, available transmission timings in a superframe is reduced, and this makes some nodes unable to transmit data. Further, nodes that have scanned and selected the same transmission timing always cause a transmission collision after that. Thus, when moving nodes are gathered and hence the density of nodes in the communicable range increases, the opportunity of transmission to a node waiting for a data transmission request is reduced. Further, even if a transmission collision repeatedly occurs, there is no scheme to change the transmission timing, and this makes it impossible to have an opportunity of retransmission of data that has caused a reception error.

Further, when a traffic intersection, a train, a place of refuge in a disaster area, etc. are crowded with people who are carrying mobile nodes and hence the mobile nodes are congested, if data exchange is performed among them, the transmission timing may be the same, causing a problem that the possibility of occurrence of a data transmission error increases.

### Problems to be Solved by Third Invention

In the case of use of such a method that achieves power saving of a node with a built-in battery, in which a superframe is formed of given time slots in time-division multiplexing two-way communications using time-slot synchronization type TDMA (Time Division Multiple Access) and a sleep period is provided in the superframe period by achieving synchronization in superframes, when the number of nodes existing in a communication range is smaller than the number of time slots in a given superframe, radio needs to remain receivable for empty time slots that may sleep, posing a problem with power saving.

Even when a method for self-sustained empty slot management as described in Patent Document 1 is employed, if communication nodes involve movement and frequently change time slots used, there is a need to scan all given time slots in order to grasp their usage status, so that frequent scans of time slots are required, thereby making it difficult to achieve power saving.

### Problems to be Solved by Fourth Invention

Upon response confirmation using a passive ACK for the above-mentioned broadcast case, a frame transmitted by a node needs to be transferred sequentially. When a frame as large as data transmitted is used and a large number of nodes perform broadcast communication, not only congestion is increased, but also response confirmation cannot be made, for example, on such a network that does not transfer broadcast frames.

### OBJECTS OF INVENTIONS

In view of the above conventional problems, it is an object of the first invention to provide a radio communication method, a radio communication system, and a radio communication device, capable of preventing a collision in such a state that radio communication devices are congested.

In view of the above conventional problems, it is an object of the second invention to provide a radio communication method, a radio communication system, and a radio communication device, capable of autonomously increasing transmission opportunities when a collision occurs in such a state that mobile nodes with low power consumption are congested, and capable of increasing the number of nodes that stop transmission to reduce the number of nodes that attempt transmission at a time.

It is an object of the third invention to provide a radio communication method, a radio communication system, and a radio communication device, capable of operating with an appropriate number of time slots in radio communication, where a radio communication device advertises its own information to an unspecified number of radio communication devices that involve movement, and hence capable of achieving power saving.

It is an object of the fourth invention to provide a congestion control method, a radio communication system, and a radio communication device, capable of autonomously stopping transmission using receipt response information that does not increase congestion during a period of congestion in radio communication, where a radio communication device advertises its own information to an unspecified number of radio communication devices, and capable of autonomously determining the elimination of a congestion state to resume transmission.

<First Invention>

In order to attain the above object, according to the first invention, there is provided a radio communication method, in which any period within a superframe of a constant cycle is defined as an active period and the rest is defined as a sleep period, and the active period is divided into plural time slots to enable each of plural radio communication devices to perform time-division two-way communication using each time slot, the method comprising:

a step of allowing each of the plural radio communication devices to detect, based on the communication condition in each time slot, such a state that plural radio communication devices are congested, and to decide one of the plural radio communication devices as a representative node;

a step of allowing a first radio communication device decided as the representative node to transmit a representative node advertisement message advertising that the first radio communication device becomes the representative node;

a step of allowing a second radio communication device, which has not been decided as the representative node, to transmit a data packet when receiving the representative node advertisement message;

a step of allowing the first radio communication device to transmit a confirmation message when receiving the data packet after transmitting the representative node advertisement message; and

a step of allowing the second radio communication device to stop data packet transmission during the next active period when receiving the confirmation message after transmitting the data packet.

This structure makes it possible to prevent a collision in such a state that radio communication devices are congested.

In order to attain the above object, according to the first invention, there is also provided a radio communication system, in which any period within a superframe of a constant cycle is defined as an active period and the rest is defined as a sleep period, and the active period is divided into plural time slots to enable each of plural radio communication devices to perform time-division two-way communication using each time slot, the system comprising:

means for allowing each of the plural radio communication devices to detect, based on the communication condition in each time slot, such a state that plural radio communication devices are congested, and to decide one of the plural radio communication devices as a representative node;

means for allowing a first radio communication device decided as the representative node to transmit a representative node advertisement message advertising that the first radio communication device becomes the representative node;

means for allowing a second radio communication device, which has not been decided as the representative node, to transmit a data packet when receiving the representative node advertisement message;

means for allowing the first radio communication device to transmit a confirmation message when receiving the data packet after transmitting the representative node advertisement message; and

means for allowing the second radio communication device to stop data packet transmission during the next active period when receiving the confirmation message after transmitting the data packet.

This structure makes it possible to prevent a collision in such a state that radio communication devices are congested.

In order to attain the above object, according to the first invention, there is further provided a radio communication device in a radio communication system, in which any period within a superframe of a constant cycle is defined as an active period and the rest is defined as a sleep period, and the active period is divided into plural time slots to enable each of plural radio communication device to perform time-division two-way communication using each time slot, the device comprising:

means for detecting, based on the communication condition in each time slot, such a state that plural radio communication devices are congested, and deciding one of the plural radio communication device as a representative node;

means for transmitting a representative node advertisement message advertising that the radio communication device becomes the representative node when having been decided as the representative node;

means for transmitting a confirmation message when receiving a data packet after transmitting the representative node advertisement message; and

means which, if having not been decided as the representative node, transmits a data packet when receiving the representative node advertisement message, and stops data packet transmission during the next active period when receiving the confirmation message after transmitting the data packet.

This structure makes it possible to prevent a collision in such a state that radio communication devices are congested.

The structure may be such that, when the data packet is not received after the confirmation message is transmitted, or when the number of collision detecting time slots is equal to or less than a reference value, transmission of the representative node advertisement message is stopped during the next active period, and when the representative node advertisement message is not received after data packet transmission is stopped, data packet transmission is resumed during the next active period.

This structure makes it possible to resume data packet transmission when the congested state of the radio communication devices is eliminated.

The structure may also be such that, when the representative node is decided, such a state that plural radio communication devices are congested is detected based on the communication condition in each time slot, a representative node candidate declaration message declaring that the radio communication device becomes a representative node candidate is transmitted during the next active period, the representative node candidate declaration message is received, and based on a predetermined method, one of the plural radio communication devices is decided as the representative node.

This structure makes it easy to decide the representative node.

The structure may further be such that, when the radio communication device decided as the representative node stops transmission of the representative node advertisement message, the priority of becoming a representative node candidate next time is reduced.

This structure makes it possible to prevent some radio communication devices from often becoming the representative node and hence becoming impossible to transmit their data packets.

<Second Invention>

In order to attain the above object, according to the second invention, there is provided a radio communication method, in which any period within a superframe of a constant cycle is defined as an active period and the rest is defined as a sleep period, and the active period is divided into plural time slots to enable each of plural radio communication device to perform time-division two-way communication using each time slot, the method comprising:

a step of allowing each of the plural radio communication devices to detect a collision in each time slot; and

a step of allowing each of the plural radio communication device not only to transmit a collision advertisement message to a predetermined time slot of the plural time slots of the next active period but also to extend the next active period when the radio communication device has detected the collision.

This structure makes it possible to autonomously increase the opportunity of transmission when a collision occurs in such a state that radio communication devices are congested.

In order to attain the above object, according to the second invention, there is also provided a radio communication method, in which any period within a superframe of a constant cycle is defined as an active period and the rest is defined as a sleep period, and the active period is divided into plural time slots to enable each of plural radio communication devices to perform time-division two-way communication using each time slot, the method comprising:

a step of allowing each of the plural radio communication device to detect a collision in each time slot; and

a step of allowing each of the plural radio communication device not only to extend the current active period but also to transmit a collision advertisement message to a predetermined time slot of the current active period when the radio communication device has detected the collision.

This structure makes it possible to autonomously increase the opportunity of transmission when a collision occurs in such a state that radio communication devices are congested.

In order to attain the above object, according to the second invention, there is provided a radio communication system, in which any period within a superframe of a constant cycle is defined as an active period and the rest is defined as a sleep period, and the active period is divided into plural time slots to enable each of plural radio communication devices to perform time-division two-way communication using each time slot, the system comprising:

means for allowing each of the plural radio communication device to detect a collision in each time slot; and

means for allowing each of the plural radio communication device not only to transmit a collision advertisement message to a predetermined time slot of the plural time slots of the next active period but also to extend the next active period when the radio communication device has detected the collision.

This structure makes it possible to autonomously increase the opportunity of transmission when a collision occurs in such a state that radio communication devices are congested.

In order to attain the above object, according to the second invention, there is also provided a radio communication system, in which any period within a superframe of a constant cycle is defined as an active period and the rest is defined as a sleep period, and the active period is divided into plural time slots to enable each of plural radio communication devices to perform time-division two-way communication using each time slot, the system comprising:

means for allowing each of the plural radio communication device to detect a collision in each time slot; and

means for allowing each of the plural radio communication device not only to extend the current active period but also to transmit a collision advertisement message to a predetermined time slot of the current active period when the radio communication device has detected the collision.

This structure makes it possible to autonomously increase the opportunity of transmission when a collision occurs in such a state that radio communication devices are congested.

In order to attain the above object, according to the second invention, there is provided a radio communication device in a radio communication system, in which any period within a superframe of a constant cycle is defined as an active period and the rest is defined as a sleep period, and the active period is divided into plural time slots to enable each of plural radio communication devices to perform time-division two-way communication using each time slot, the device comprising:

means for detecting a collision in each time slot; and

means for not only transmitting a collision advertisement message to a predetermined time slot of the plural time slots of the next active period but also extending the next active period when the radio communication device has detected the collision.

This structure makes it possible to autonomously increase the opportunity of transmission when a collision occurs in such a state that radio communication devices are congested.

In order to attain the above object, according to the second invention, there is also provided a radio communication device in a radio communication system, in which any period within a superframe of a constant cycle is defined as an active period and the rest is defined as a sleep period, and the active period is divided into plural time slots to enable each of plural radio communication devices to perform time-division two-way communication using each time slot, the device comprising:

means for detecting a collision in each time slot; and

means for not only extending the current active period but also transmitting a collision advertisement message to a predetermined time slot of the current active period when the radio communication device has detected the collision.

This structure makes it possible to autonomously increase the opportunity of transmission when a collision occurs in such a state that radio communication devices are congested.

The structure may be such that the radio communication device that has detected the collision transmits the collision advertisement message together with data to another time slot for transmitting the data during the current active period as well as to the predetermined time slot.

This structure makes it possible to autonomously increase the opportunity of transmission when a collision occurs in such a state that radio communication devices are congested.

The structure may also be such that

the collision advertisement message includes time slot identification information indicative of the time slot that has detected the collision, and

each of the plural radio communication devices that have received the collision advertisement message stops next transmission when a time slot transmitted by itself last time does not match the time slot identification information in the collision advertisement message.

This structure makes it possible to increase the number of nodes that stop transmission in order to reduce the number of nodes that attempt transmission at a time.

<Third Invention>

In order to attain the above object, according to the third invention, there is provided a radio communication method, in which any period within a superframe of a constant cycle is defined as an active period and the rest is defined as a sleep period, and the active period is divided into plural time slots to enable each of plural radio communication devices to perform time-division two-way communication using each time slot, the method comprising:

a step of allowing each of the plural radio communication devices to transmit a frame including a field of receipt response information on a frame received from another radio communication device in each of the plural time slots during each time slot period; and

a step of allowing each of the plural radio communication devices that have received the frame to increase or decrease the number of time slots used by its own device during the next superframe period based on each piece of receipt response information in the field of the receipt response information within the previous superframe period.

This structure makes it possible to operate with an appropriate number of time slots and hence to achieve power saving.

The structure may be such that

when each of the plural radio communication devices was not able to transmit a frame, its own device further transmits a flag indicative thereof in a frame to be transmitted next, and

each of the plural radio communication devices that have received the frame increases the number of time slots used by its own device by the number of flags within the frame.

The structure may also be such that, when the receipt response information contains error information, the number of time slots used is increased by the number of pieces of error information.

This structure makes it possible to increase, in a stroke, the number of time slots that are in short supply.

In order to attain the above object, according to the third invention, there is also provided a radio communication system, in which any period within a superframe of a constant cycle is defined as an active period and the rest is defined as a sleep period, and the active period is divided into plural time slots to enable each of plural radio communication devices to perform time-division two-way communication using each time slot, the system comprising:

means for allowing each of the plural radio communication devices to transmit a frame including a field of receipt response information on a frame received from another radio communication device in each of the plural time slots during each time slot period; and

means for allowing each of the plural radio communication devices that have received the frame to increase or decrease the number of time slots used by its own device during the next superframe period based on each piece of receipt response information in the field of the receipt response information within the previous superframe period.

This structure makes it possible to operate with a suitable number of slots and hence to achieve power saving.

The structure may be such that

when each of the plural radio communication devices was not able to transmit a frame, its own device further transmits a flag indicative thereof in a frame to be transmitted next, and

each of the plural radio communication devices that have received the frame increases the number of time slots used by its own device by the number of flags within the frame.

This structure makes it possible to increase, in a stroke, the number of time slots that are in short supply.

In order to attain the above object, according to the third invention, there is further provided a radio communication device in a radio communication system, in which any period within a superframe of a constant cycle is defined as an active period and the rest is defined as a sleep period, and the active period is divided into plural time slots to enable each of plural radio communication devices to perform time-division two-way communication using each time slot, the device comprising:

means for transmitting a frame including a field of receipt response information on a frame received from another radio communication device in each of the plural time slots during each time slot period; and

means which, when having received the frame, increases or decreases the number of time slots used by its own device during the next superframe period based on each piece of receipt response information in the field of the receipt response information within the previous superframe period.

This structure makes it possible to operate with an appropriate number of time slots and hence to achieve power saving.

The structure may be such that the radio communication device further comprising:

means which, when its own device was not able to transmit a frame, transmits a flag indicative thereof in a frame to be transmitted next, and

means which, when having received the frame, increases the number of time slots used by its own device by the number of flags within the frame.

This structure makes it possible to increase, in a stroke, the number of time slots that are in short supply.

<Fourth Invention>

In order to attain the above object, according to the fourth invention, there is provided a congestion control method in a radio communication system, in which any period within a superframe of a constant cycle is defined as an active period and the rest is defined as a sleep period, and the active period is divided into plural time slots to enable each of plural radio communication devices to perform time-division two-way communication using each time slot, the method comprising:

a step of allowing each of the plural radio communication devices to transmit a frame including a field of receipt response information on a frame received from another radio communication device in each of the plural time slots during each time slot period; and

a step of allowing each of the plural radio communication devices that have received the frame to determine whether to stop transmission of its own device during the next superframe period based on each piece of receipt response information in the field of the receipt response information within the previous superframe period.

This structure makes it possible to broadcast, during each superframe period, receipt response information on a frame received from each of plural radio communication devices during each time slot period in order to determine whether to stop transmission of its own device during the next superframe period.

The structure may be such that

the receipt response information consists of information indicative of “no reception,” “successful reception,” or “error reception,” and

in the determination step, it is determined whether the total number of pieces of information of “successful reception” and “error reception” in the field of the receipt response information within the previous superframe period exceeds a first threshold value to determine whether to stop transmission of its own device during the next superframe period.

This structure makes it possible to determine whether to stop transmission of its own device during the next superframe period.

The structure may also be such that the receipt response information consists of information indicative of “no reception,” “successful reception,” or “error reception,” and

in the determination step, it is determined whether the number of pieces of information of “successful reception” in the field of the receipt response information within the previous superframe period exceeds a second threshold value to determine whether to stop transmission of its own device during the next superframe period.

This structure makes it possible to determine whether to stop transmission of its own device during the next superframe period.

The structure may further be such that

the receipt response information consists of information indicative of “no reception,” “successful reception,” or “error reception,” and

in the determination step, it is determined whether the number of pieces of information of “successful reception” for a time slot used by its own node in the field of the receipt response information within the previous superframe period exceeds a third threshold value to determine whether to stop transmission of its own device during the next superframe period.

This structure makes it possible to determine whether to stop transmission of its own device during the next superframe period.

Further, the structure may be such that

when having stopped transmission of its own node in the determination step, it is determined whether to resume transmission of its own device during the next superframe period based on each piece of receipt response information in the field of the receipt response information within the previous superframe period.

This structure makes it possible to determine whether to resume transmission of its own device during the next superframe period.

In order to attain the above object, according to the fourth invention, there is also provided a radio communication system, in which any period within a superframe of a constant cycle is defined as an active period and rest is defined as a sleep period, and the active period is divided into plural time slots to enable each of plural radio communication devices to perform time-division two-way communication using each time slot, the system comprising:

means for allowing each of the plural radio communication devices to transmit a frame including a field of receipt response information on a frame received from another radio communication device in each of the plural time slots during each time slot period; and

means for allowing each of the plural radio communication devices that have received the frame to determine whether to stop transmission of its own device during the next superframe period based on each piece of receipt response information in the field of the receipt response information within previous superframe period.

This structure makes it possible to broadcast, during each superframe period, receipt response information on a frame received from each of plural radio communication devices during each time slot period in order to determine whether to stop transmission of its own device during the next superframe period.

The structure may be such that

the receipt response information consists of information indicative of “no reception,” “successful reception,” or “error reception,” and

the determination means determines whether the total number of pieces of information of “successful reception” and “error reception” in the field of the receipt response information within the previous superframe period exceeds a first threshold value to determine whether to stop transmission of its own device during the next superframe period.

This structure makes it possible to determine whether to stop transmission of its own device during the next superframe period.

The structure may also be such that

the receipt response information consists of information indicative of “no reception,” “successful reception,” or “error reception,” and

the determination means determines whether the number of pieces of information of “successful reception” in the field of the receipt response information within the previous superframe period exceeds a second threshold value to determine whether to stop transmission of its own device during the next superframe period.

This structure makes it possible to determine whether to stop transmission of its own device during the next superframe period.

The structure may further be such that

the receipt response information consists of information indicative of “no reception,” “successful reception,” or “error reception,” and

the determination means determines whether the number of pieces of information of “successful reception” for a time slot used by its own node in the field of the receipt response information within the previous superframe period exceeds a third threshold value to determine whether to stop transmission of its own device during the next superframe period.

This structure makes it possible to determine whether to stop transmission of its own device during the next superframe period.

Further, the structure may be such that

when having stopped transmission of its own node, the determination means determines whether to resume transmission of its own device during the next superframe period based on each piece of receipt response information in the field of the receipt response information within the previous superframe period.

This structure makes it possible to determine whether to resume transmission of its own device during the next superframe period.

In order to attain the above object, according to the fourth invention, there is further provided a radio communication device in a radio communication system, in which any period within a superframe of a constant cycle is defined as an active period and rest is defined as a sleep period, and the active period is divided into plural time slots to enable each of plural radio communication devices to perform time-division two-way communication using each time slot, the device comprising:

means for transmitting a frame including a field of receipt response information on a frame received from another radio communication device in each of the plural time slots during each time slot period; and

means which, when having received the frame, determines whether to stop transmission of its own device during the next superframe period based on each piece of receipt response information in the field of the receipt response information within the previous superframe period.

This structure makes it possible to broadcast, during each superframe period, receipt response information on a frame received from each of plural radio communication devices during each time slot period in order to determine whether to stop transmission of its own device during the next superframe period.

The structure may be such that

the receipt response information consists of information indicative of “no reception,” “successful reception,” or “error reception,” and

the determination means determines whether the total number of pieces of information of “successful reception” and “error reception” in the field of the receipt response information within the previous superframe period exceeds a first threshold value to determine whether to stop transmission of its own device during the next superframe period.

This structure makes it possible to determine whether to stop transmission of its own device during the next superframe period.

The structure may also be such that

the receipt response information consists of information indicative of “no reception,” “successful reception,” or “error reception,” and

the determination means determines whether the number of pieces of information of “successful reception” in the field of the receipt response information within the previous superframe period exceeds a second threshold value to determine whether to stop transmission of its own device during the next superframe period.

This structure makes it possible to determine whether to stop transmission of its own device during the next superframe period.

The structure may further be such that

the receipt response information consists of information indicative of “no reception,” “successful reception,” or “error reception,” and

the determination means determines whether the number of pieces of information of “successful reception” for a time slot used by its own node in the field of the receipt response information within the previous superframe period exceeds a third threshold value to determine whether to stop transmission of its own device during the next superframe period.

This structure makes it possible to determine whether to stop transmission of its own device during the next superframe period.

Further, the structure may be such that

when having stopped transmission of its own node, the determination means determines whether to resume transmission of its own device during the next superframe period based on each piece of receipt response information in the field of the receipt response information within the previous superframe period.

This structure makes it possible to determine whether to resume transmission of its own device during the next superframe period.

### EFFECTS OF INVENTIONS

According to the first invention, when the frequency of occurrence of transmission collisions in such a state that mobile nodes with low power consumption are congested increases to reduce the rate of data packet reachability, a node can confirm the presence of nodes that have received a data packet transmitted by its own node. Further, a node that was able to confirm the delivery of a data packet to peripheral nodes temporarily stops data transmission, and this can reduce the number of nodes that attempt to use the same time slot. Thus, the success rate of data packet transmission can be increased while acknowledging the data packet.

According to the second invention, when a collision has occurred in such a state that mobile nodes with low power consumption are congested, transmission opportunities can be autonomously increased. The number of nodes that stop transmission is also increased, and this can reduce the number of nodes that attempt transmission at a time. As a result, nodes are allowed to autonomously have more transmission opportunities, increasing the success rate of data packet transmission even in such a state that the nodes are congested. Further, nodes can have opportunities to retransmit data that has not received due to a transmission collision.

According to the third invention, a node estimates the number of nodes existing around it using efficient receipt response information from plural nodes to operate with a limited number of time slots in radio communication, where the node advertises its own information to an unspecified number of radio communication devices (nodes). This makes it possible to reduce power consumption without using unnecessary time slots during communication among fewer nodes. Further, the node is provided with a flag bit in a field of receipt response to indicate that it was not able to transmit, and this allows the node to know how many time slots are in short supply, making it possible to increase the number of time slots efficiently.

According to the fourth invention, it is possible for a node to stop and resume transmission autonomously using efficient receipt response information from plural nodes in radio communication, where the node advertises its own information to an unspecified number of radio communication devices (nodes). This makes it possible for nodes having the same function alone to autonomously avoid congestion, eliminating the need to use a specific control node separately. Further, receipt responses from plural nodes are set as receipt responses for time slots, and this makes it possible to reduce the amount of additional information for receipt responses, eliminating the increase in the amount of transmitted data. Further, the node stops transmission after confirming, using the receipt responses from the plural nodes, reception of a frame transmitted by its own node, and this makes it possible to stop transmission with assurance that there are nodes that have received the frame transmitted by its own node. In addition, it is possible to determine a congestion state from information included in a few frames received in time-division multiplexing communications that build plural time slots. In this case, there is no need to receive all time slots in order to determine congestion, and this makes it possible to reduce power consumption during congestion.

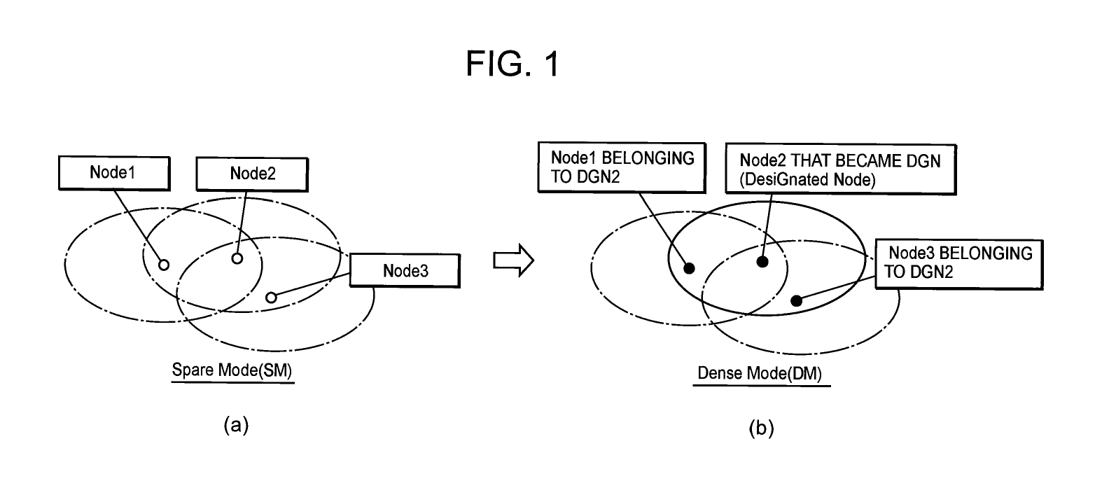

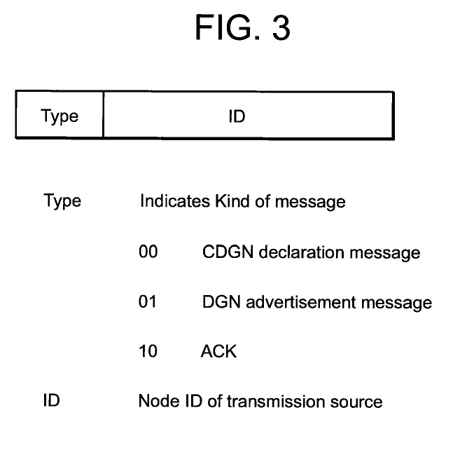

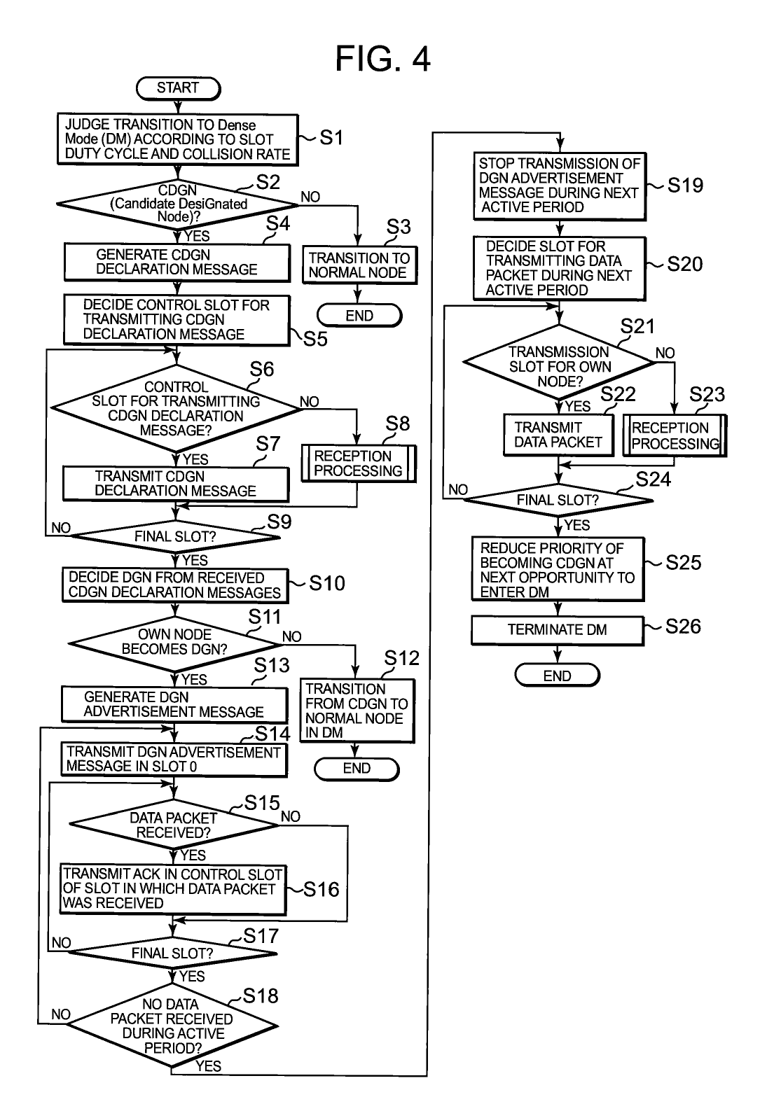

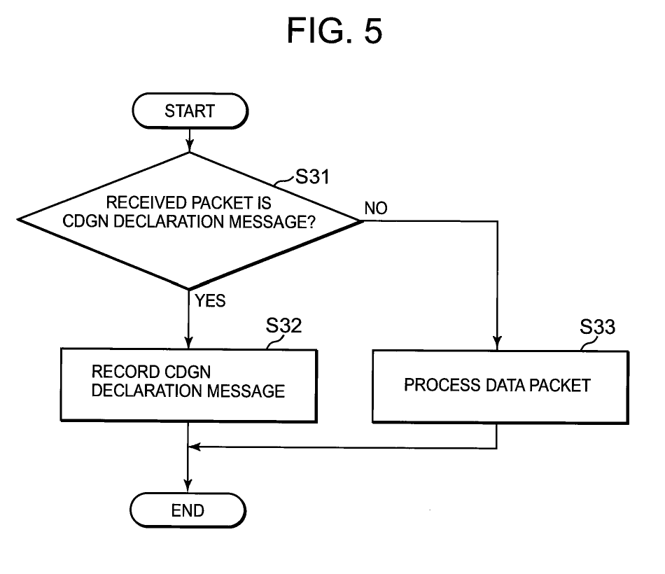

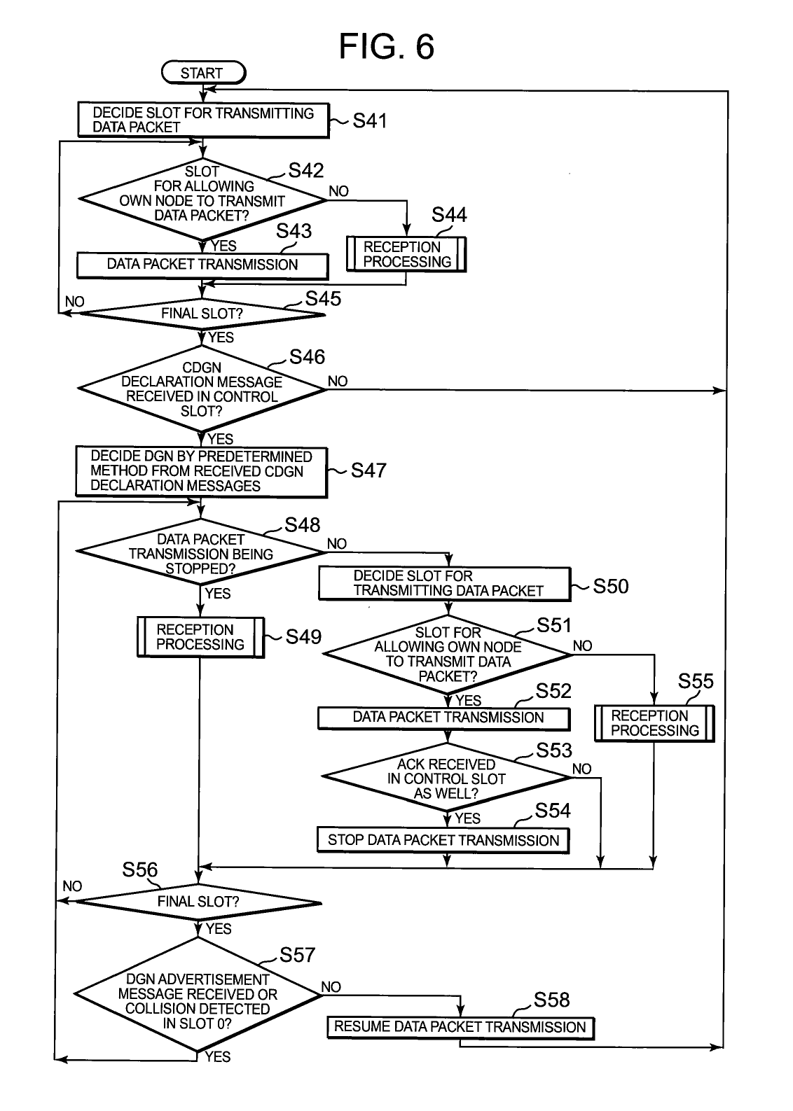

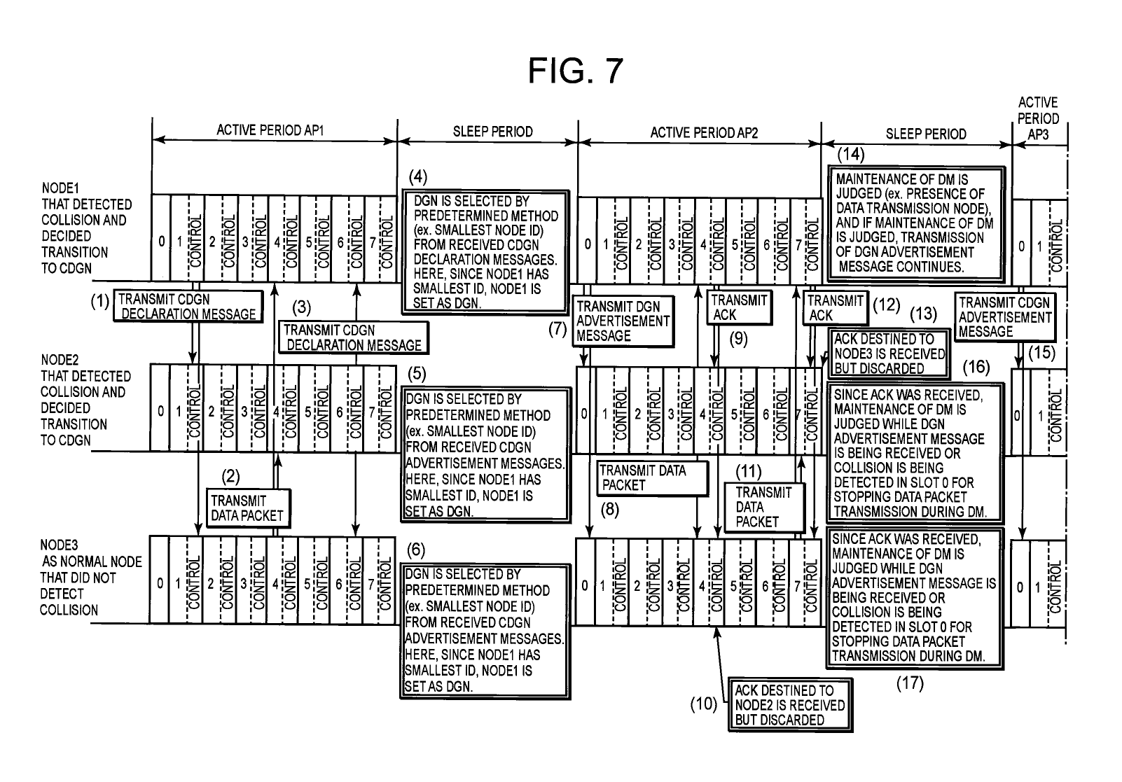

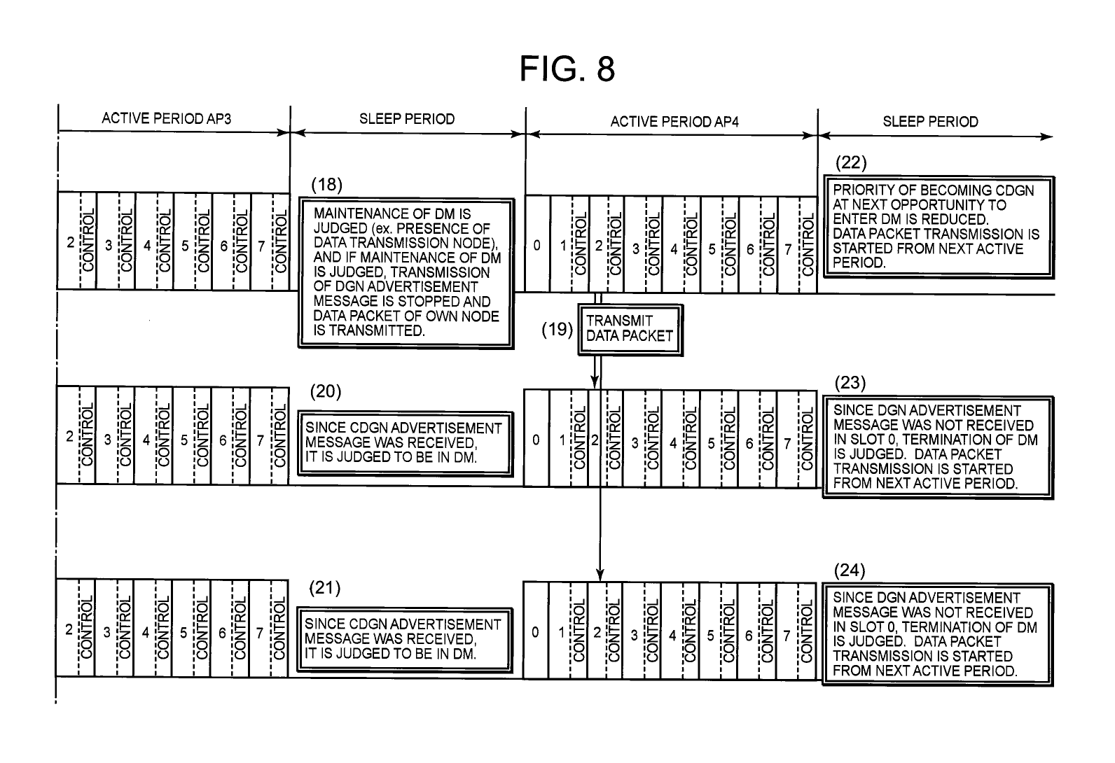

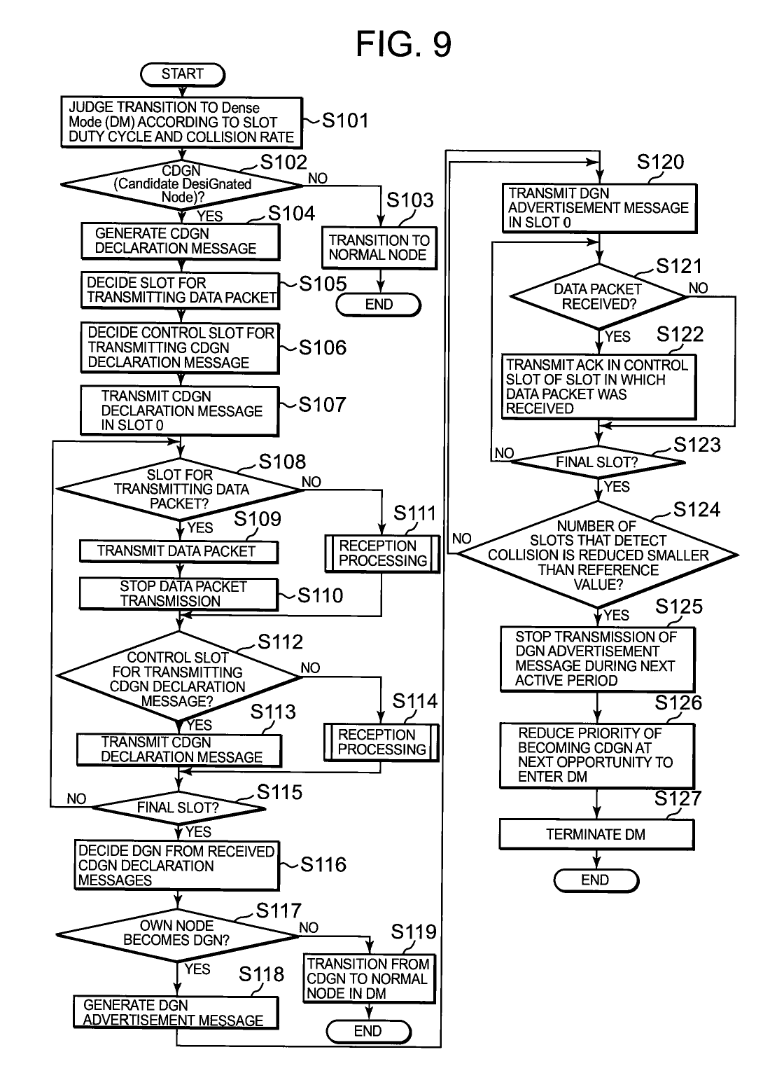

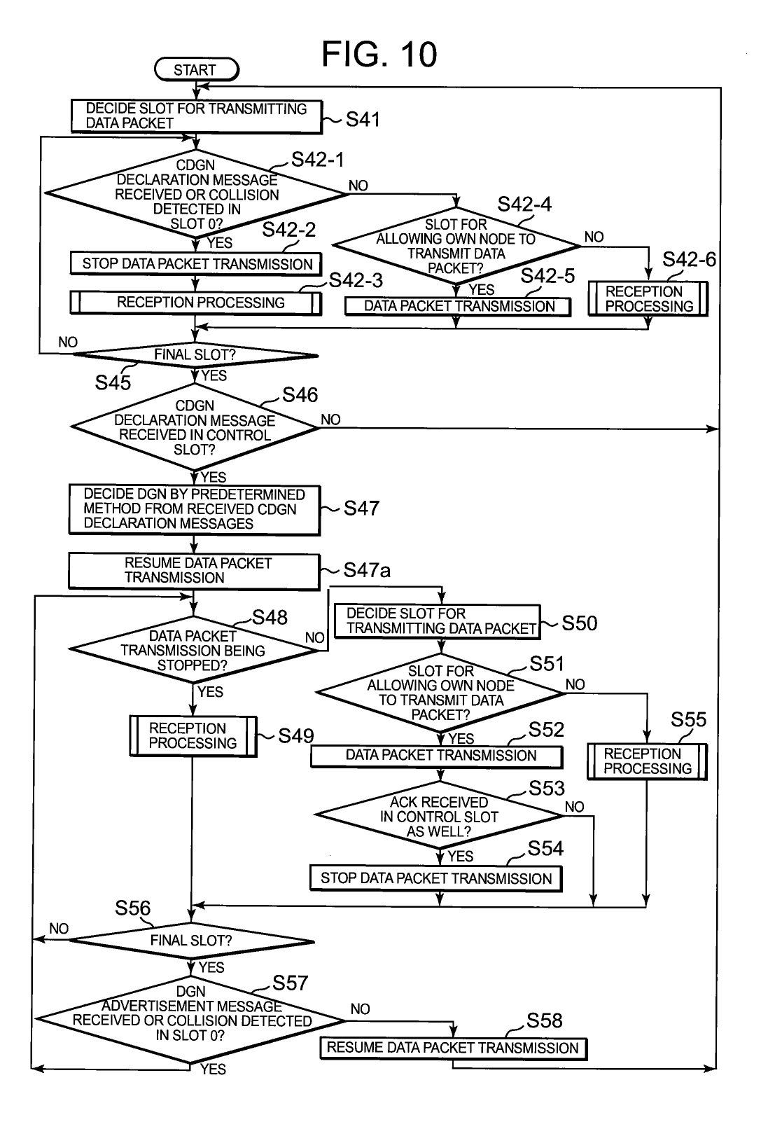

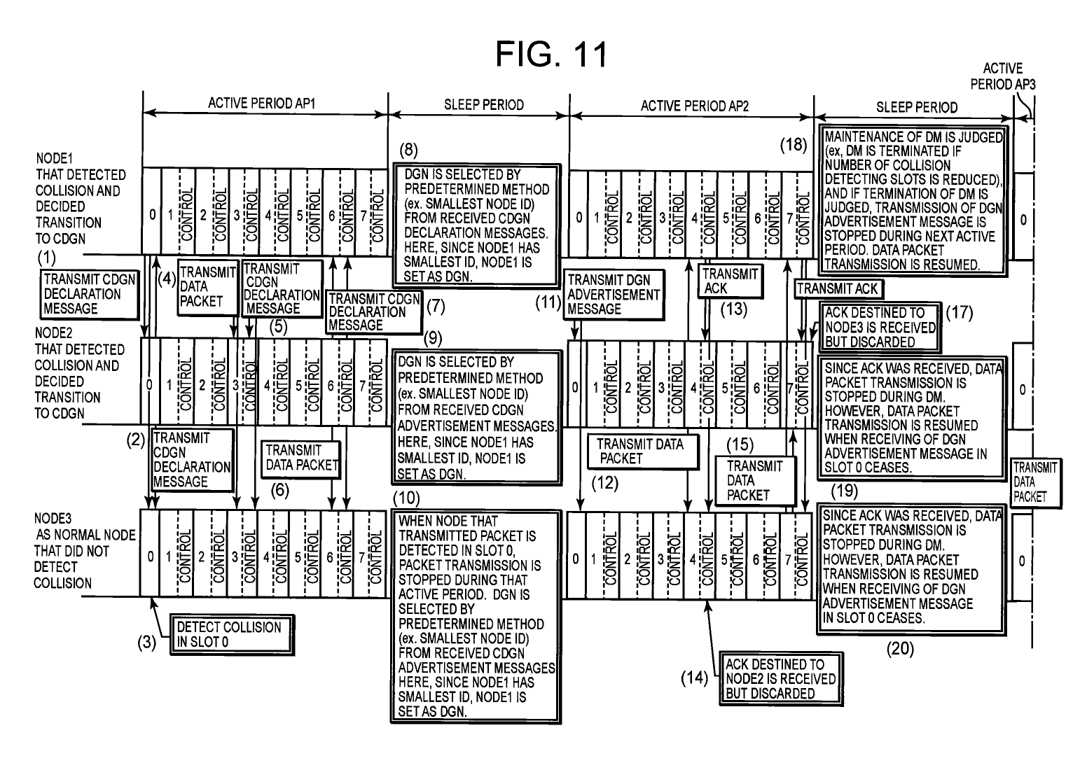

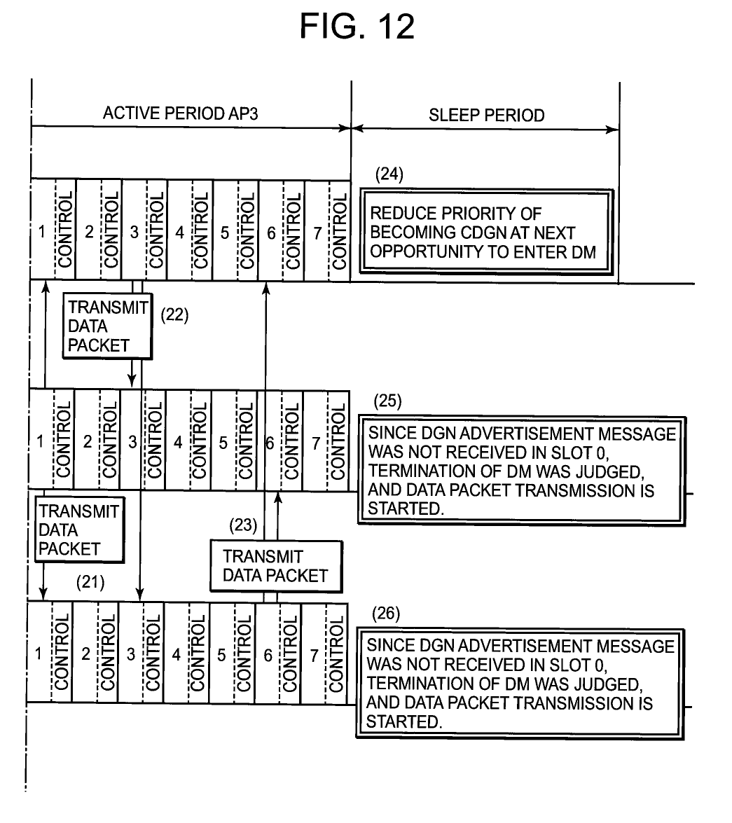

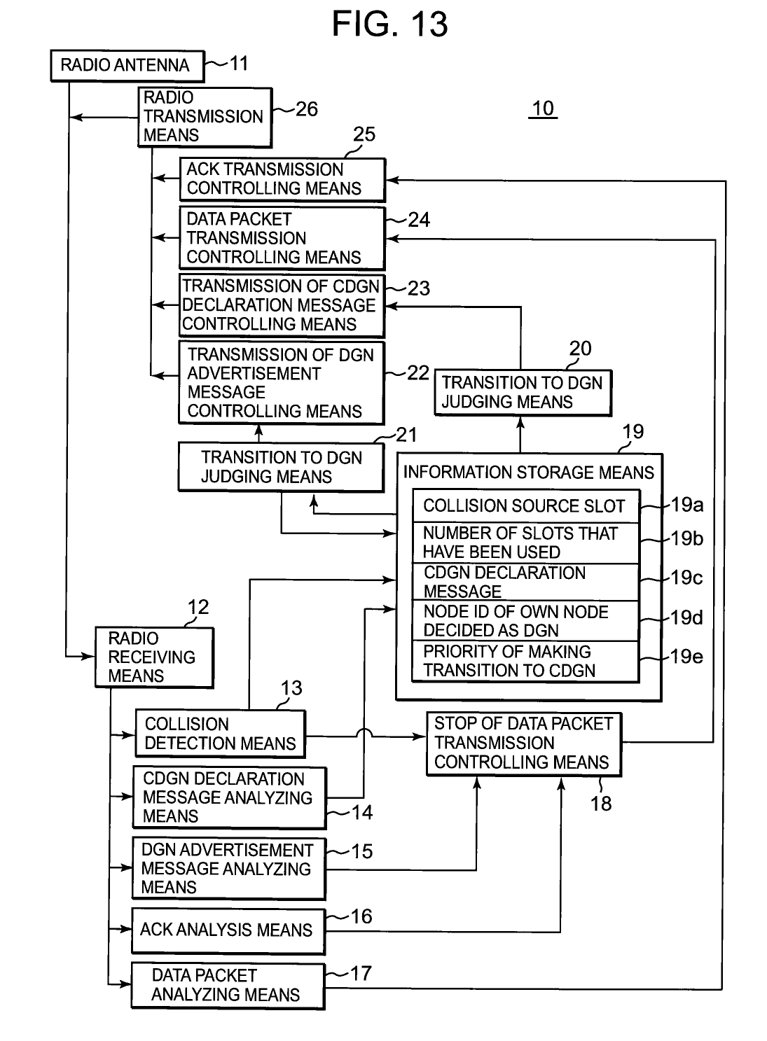

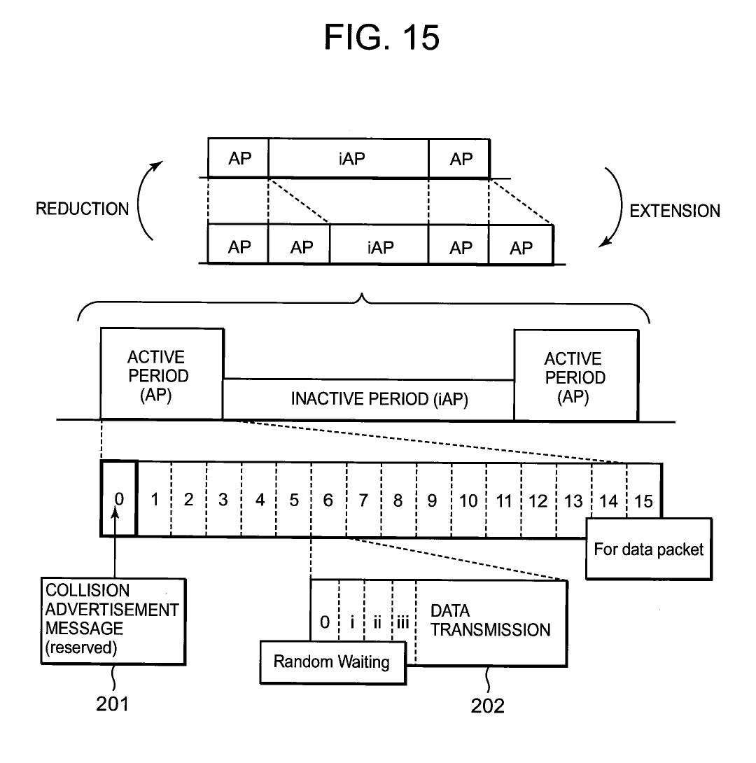

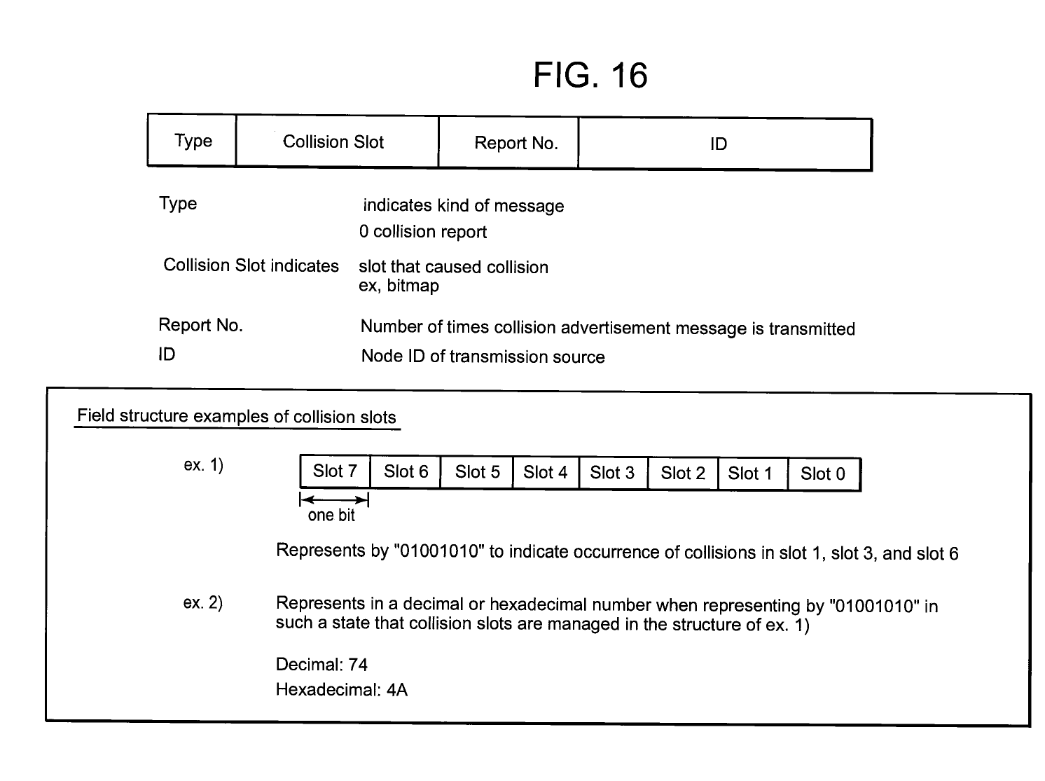

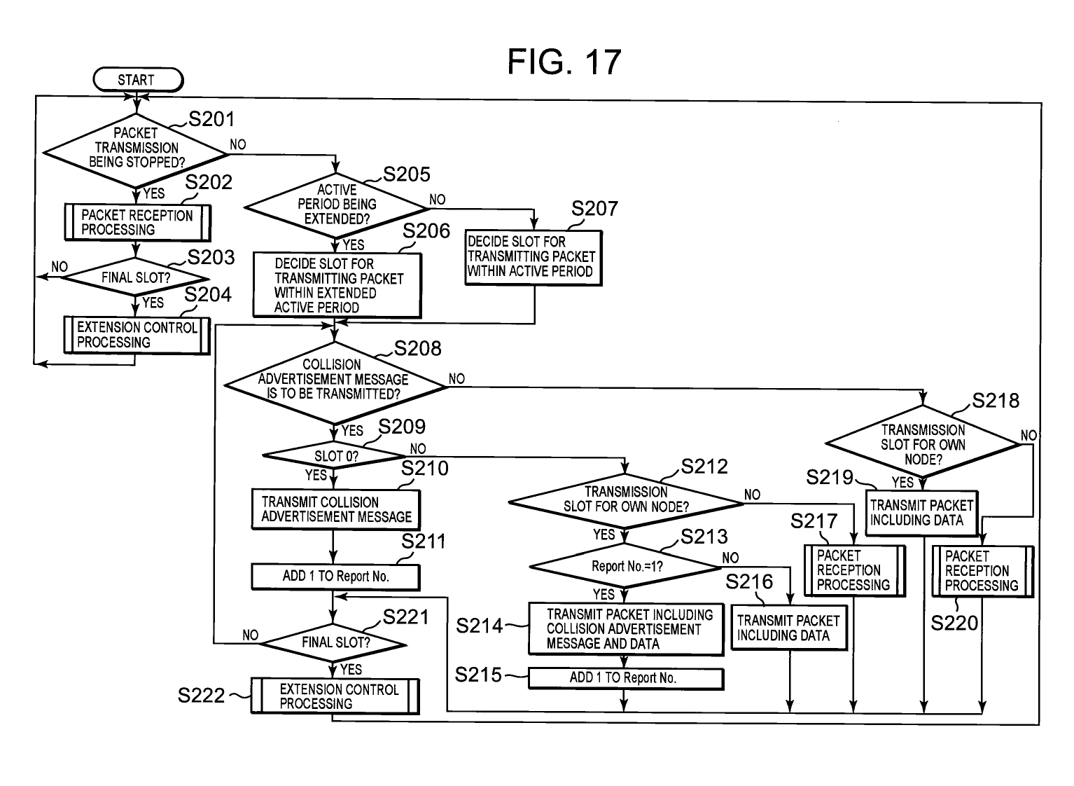

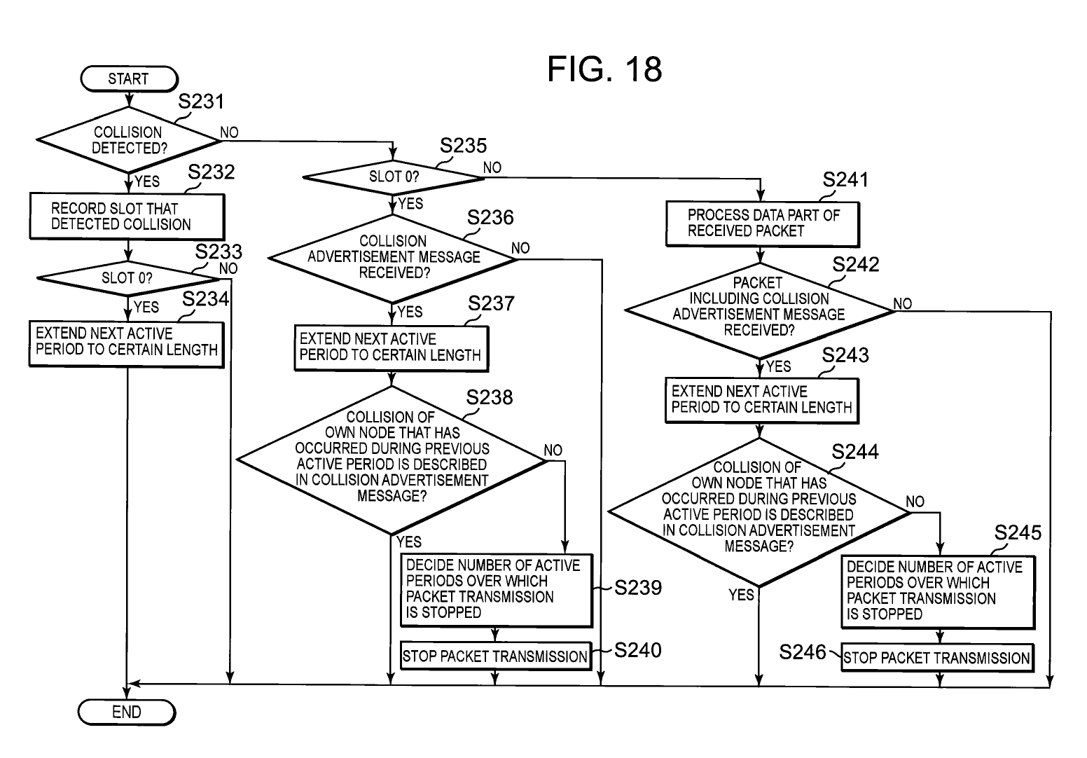

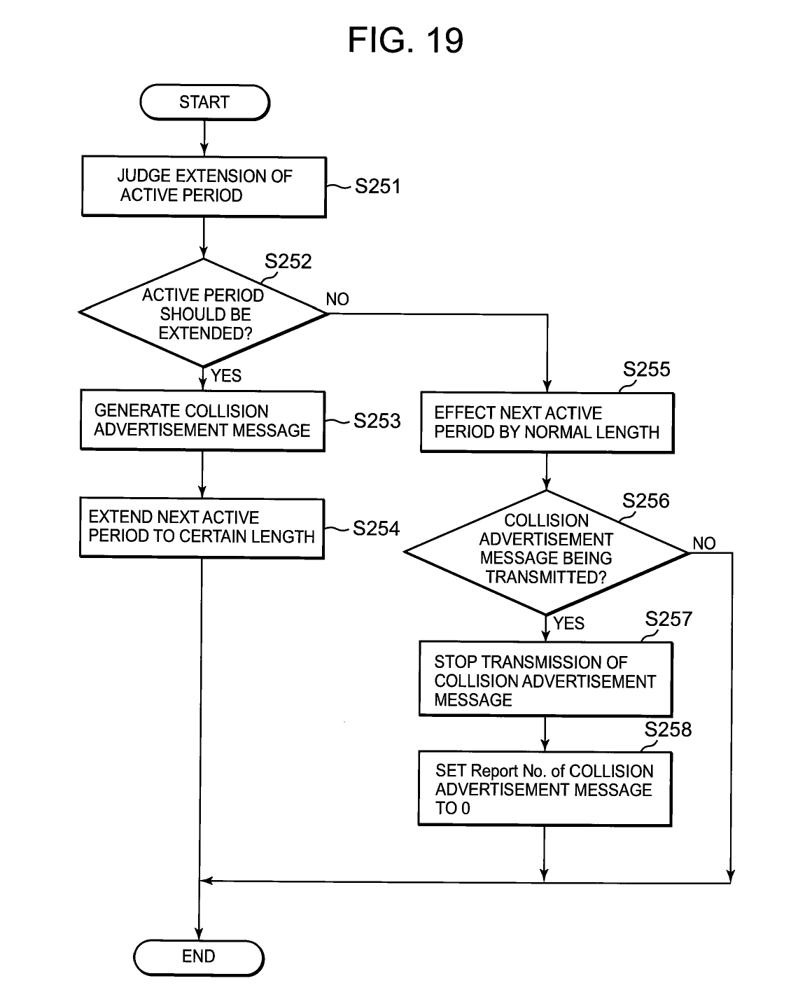

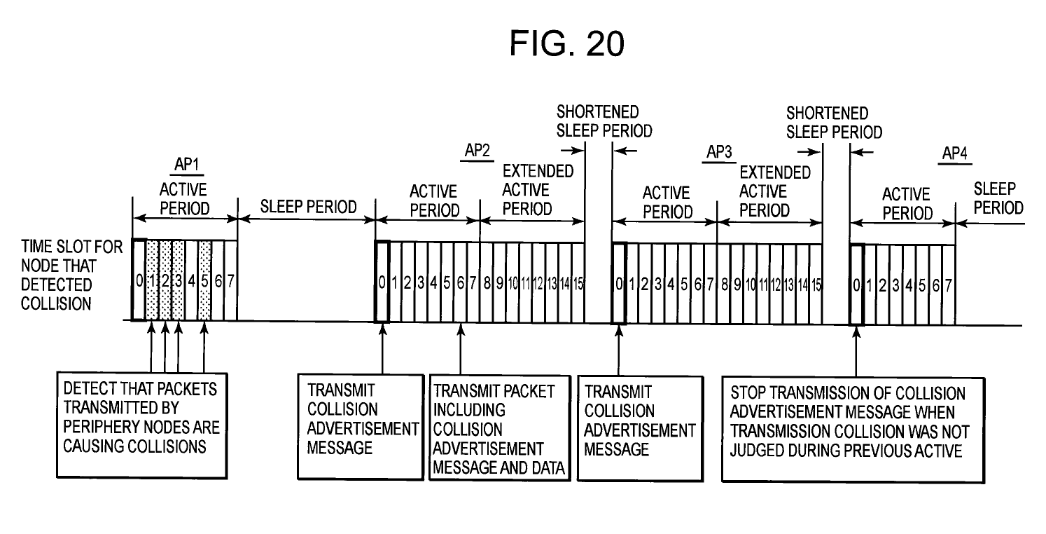

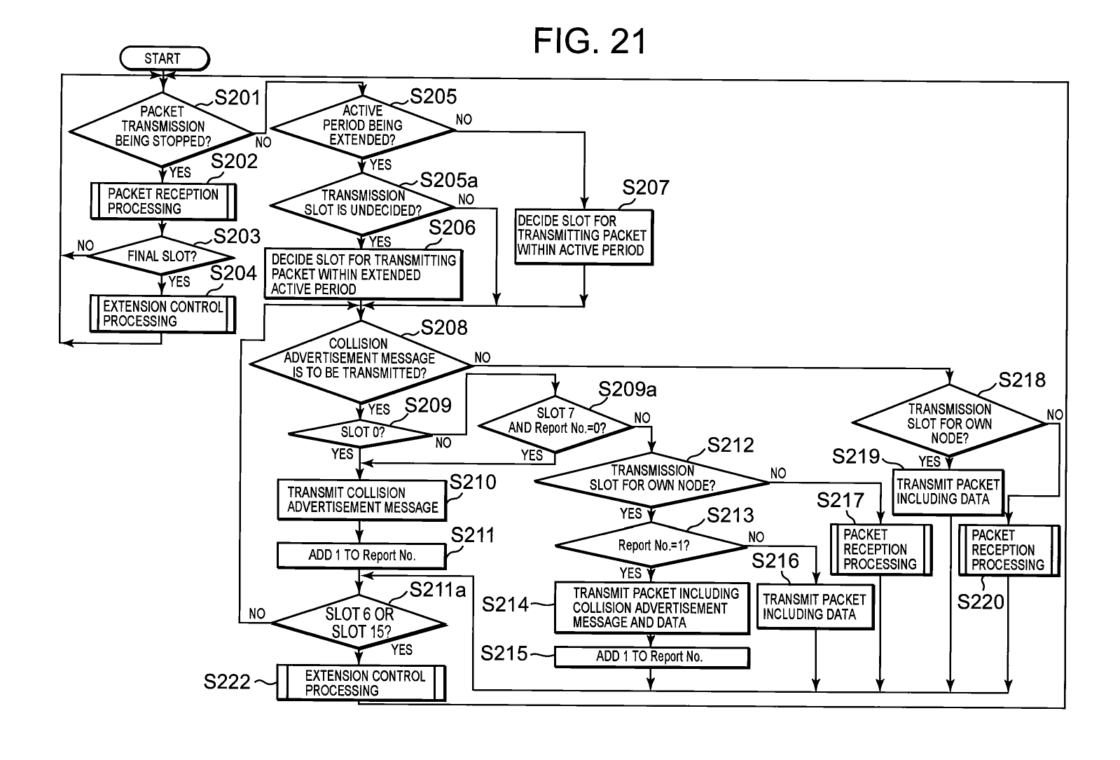

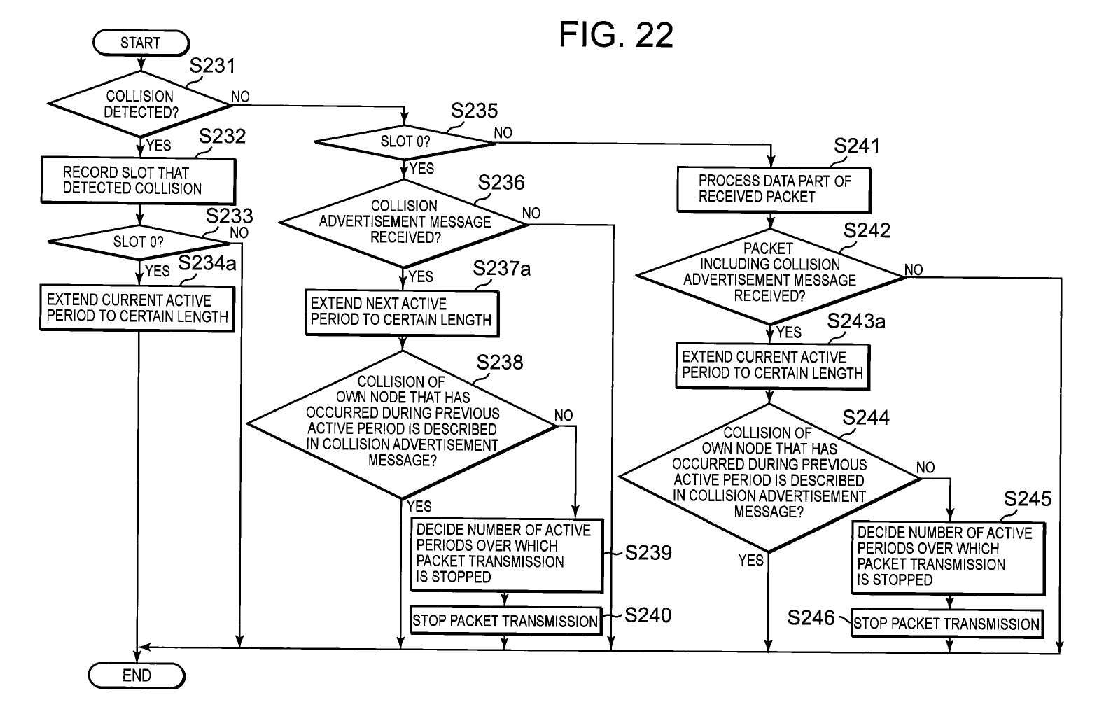

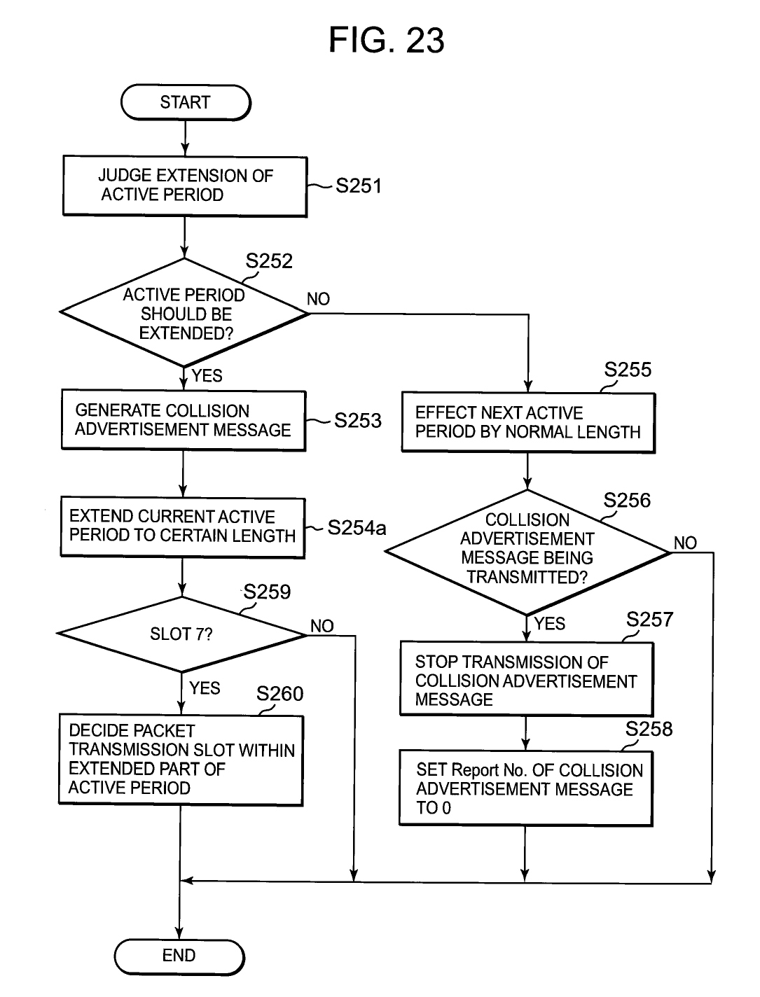

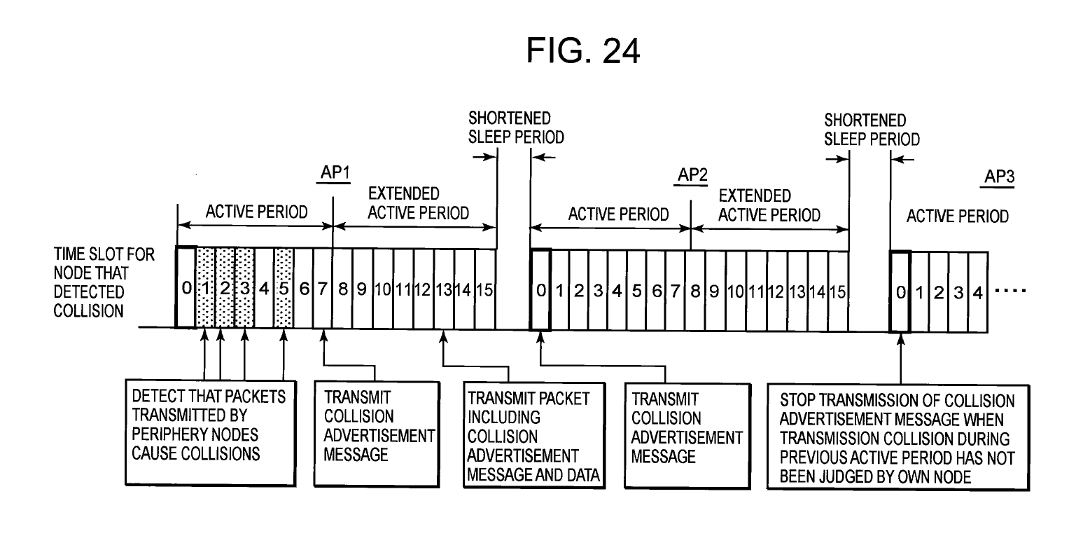

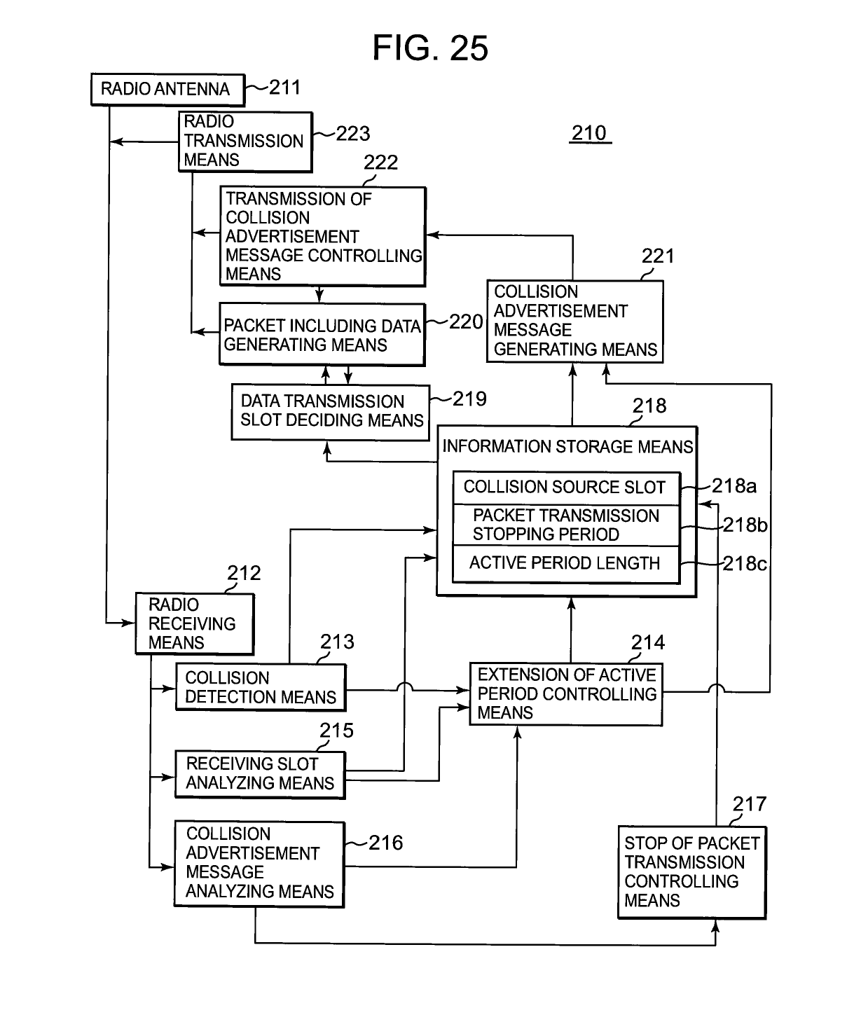

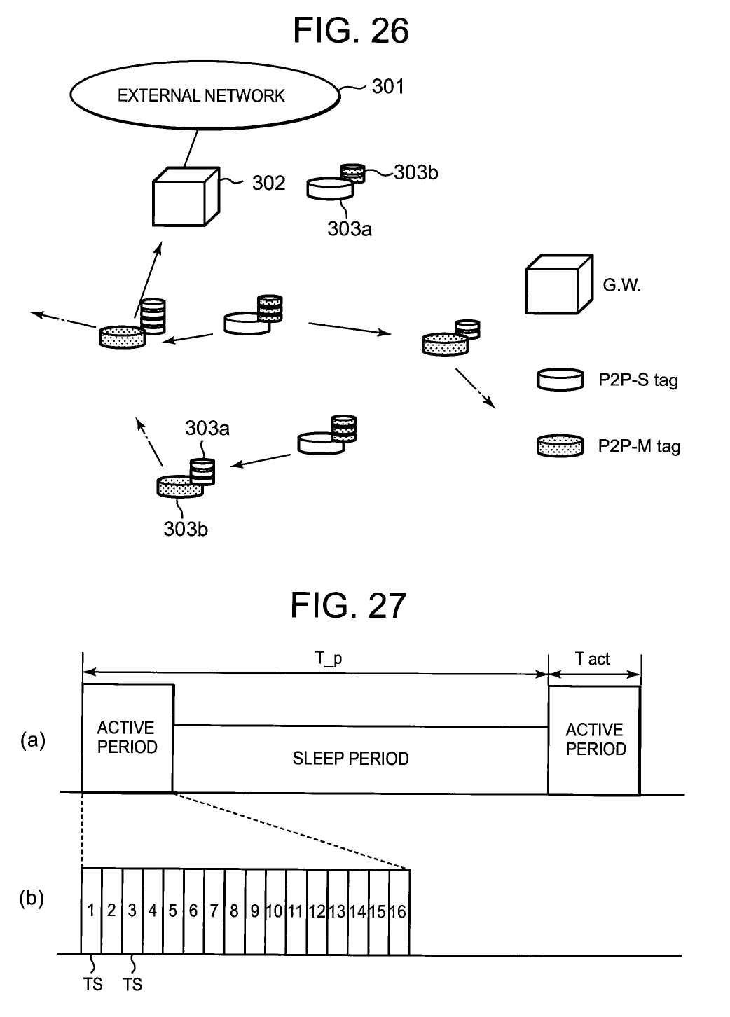

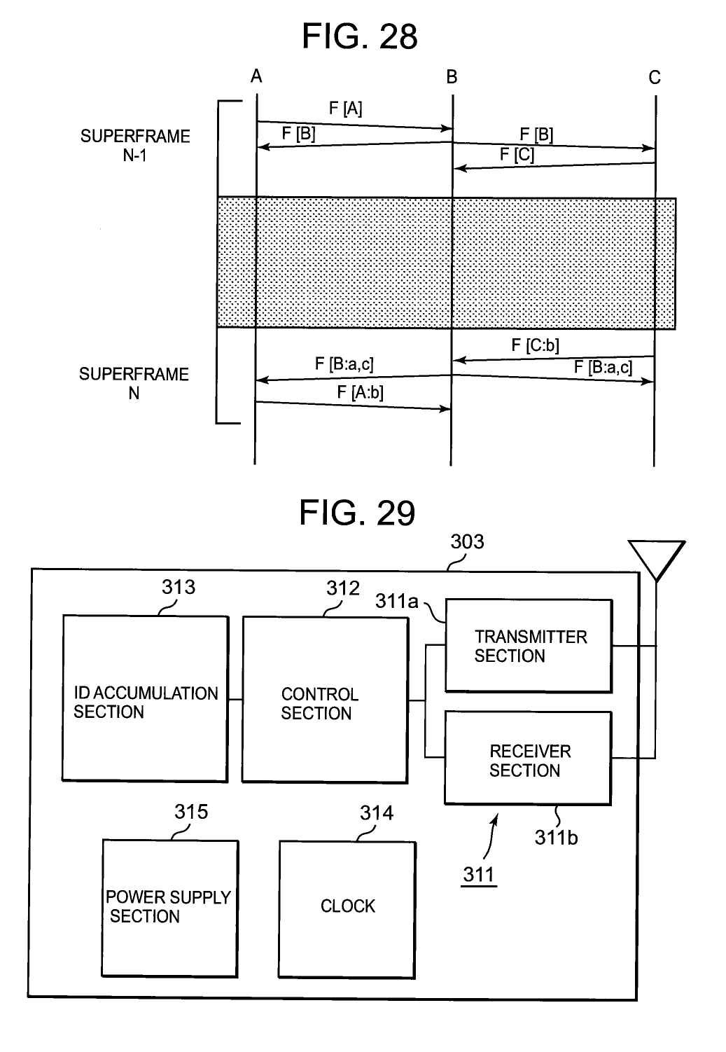

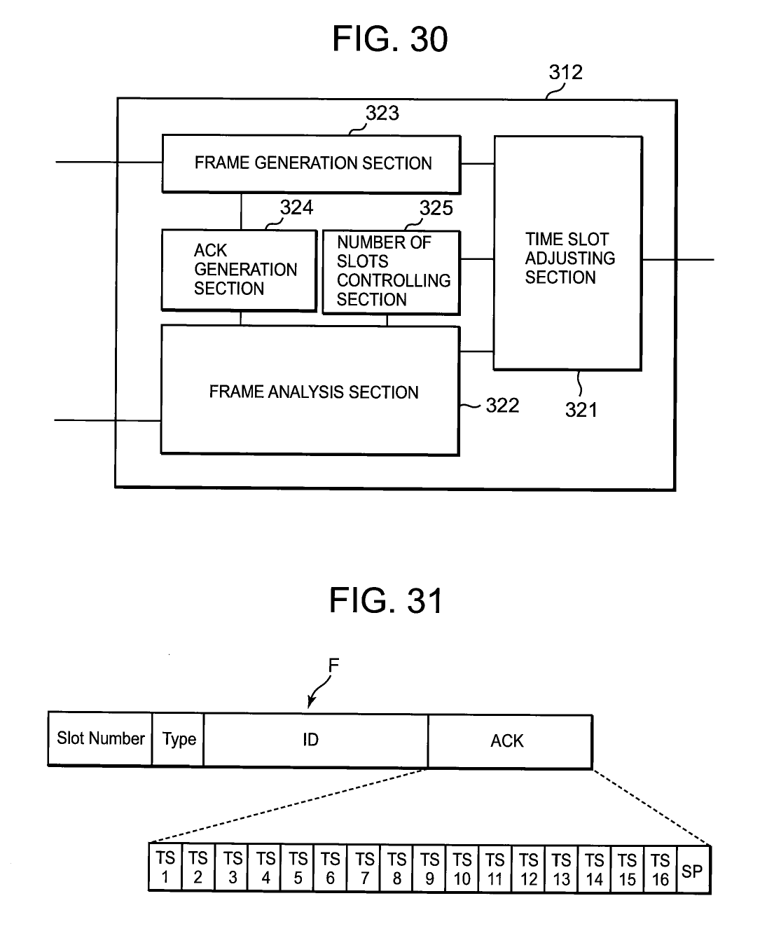

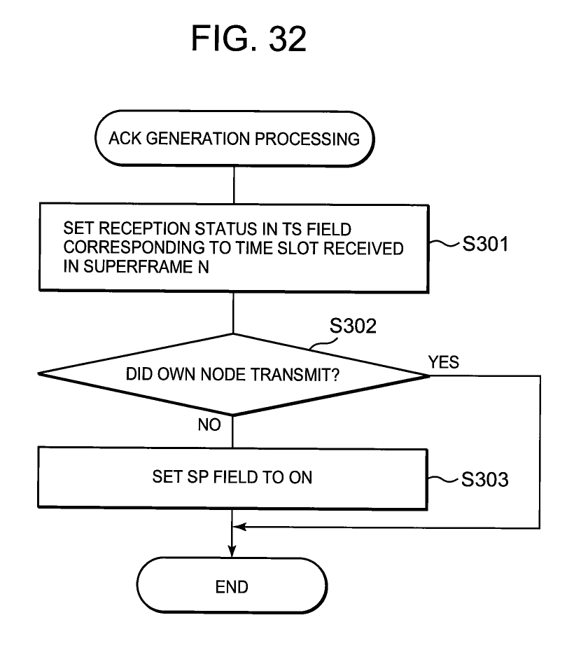

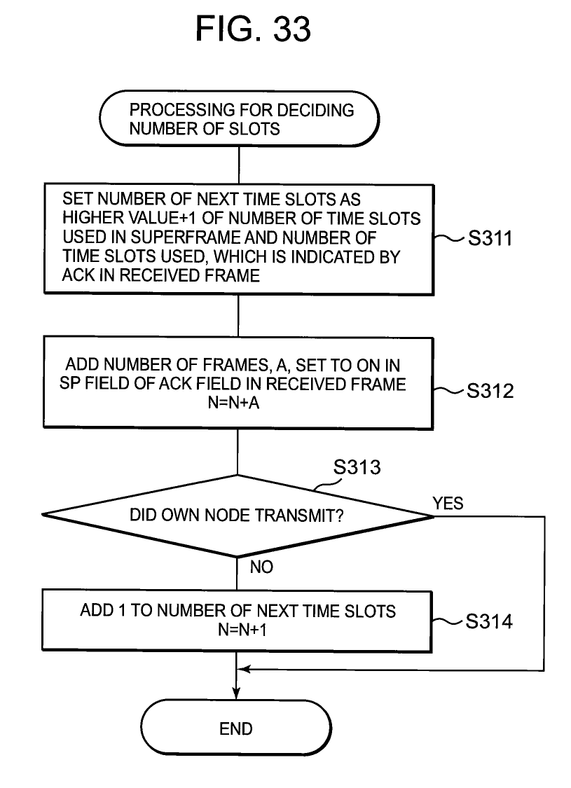

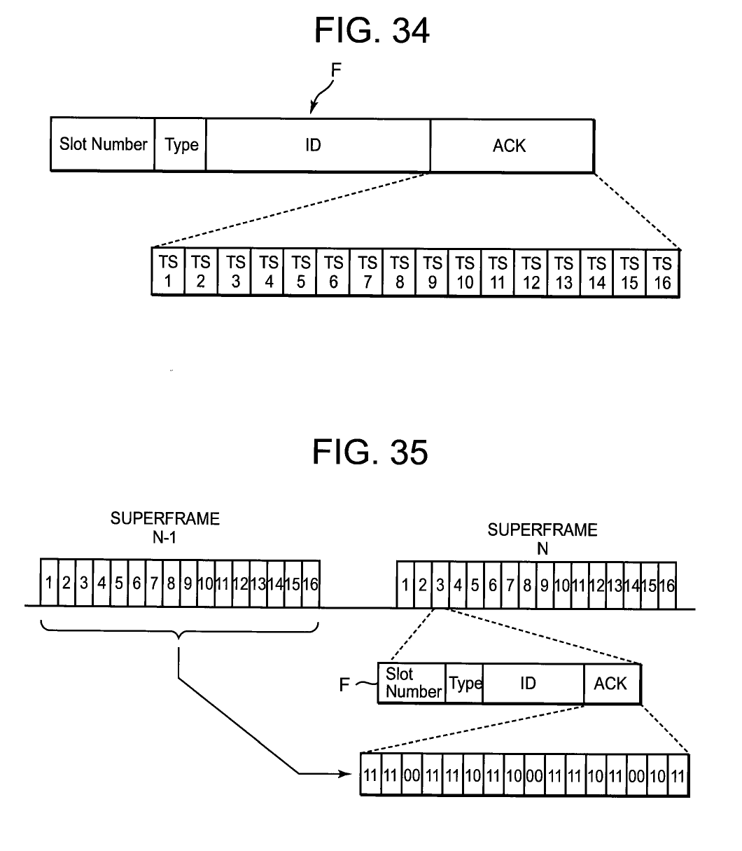

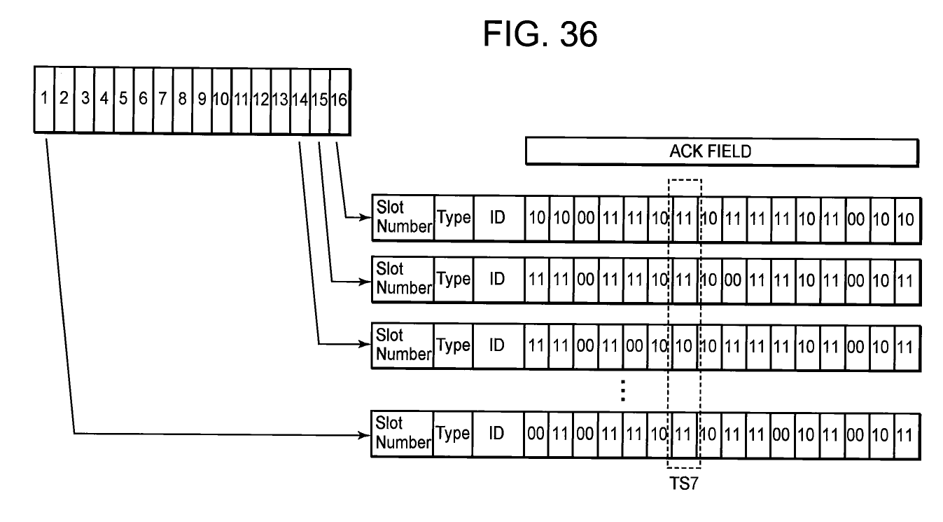

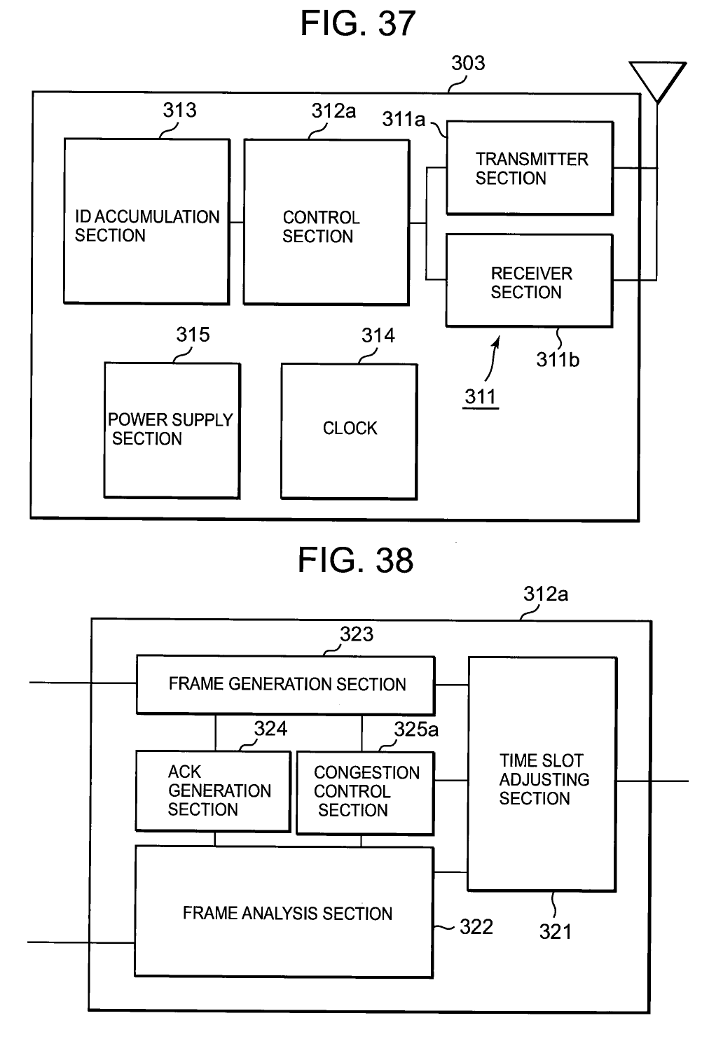

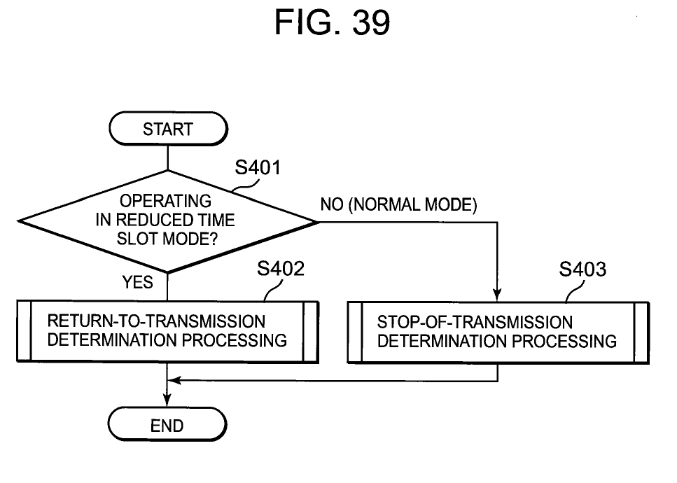

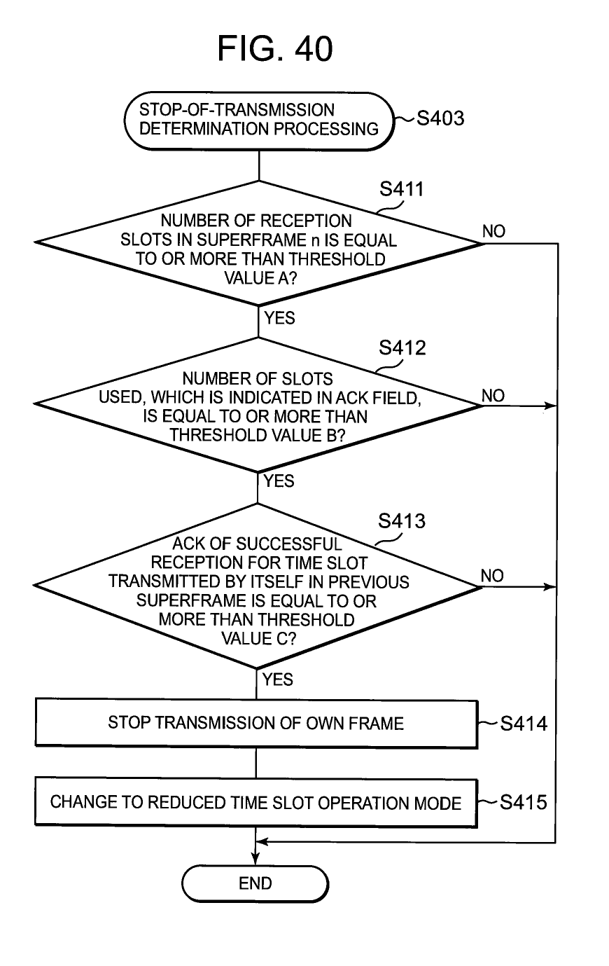

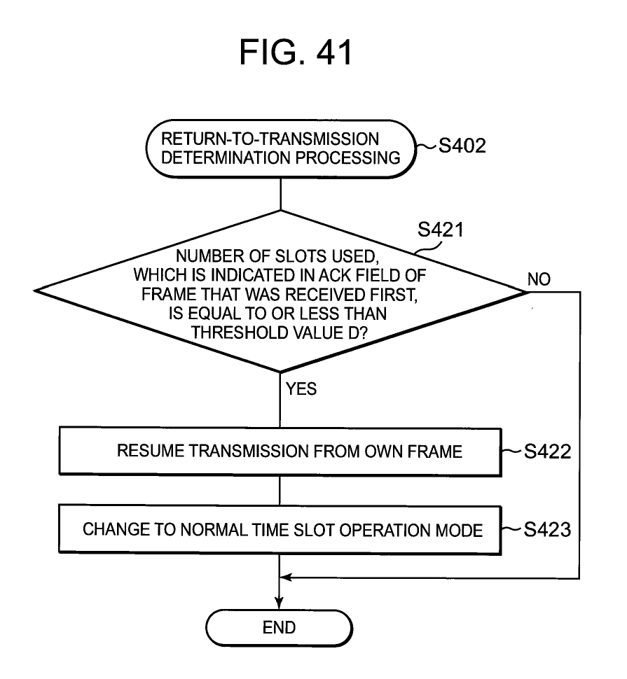

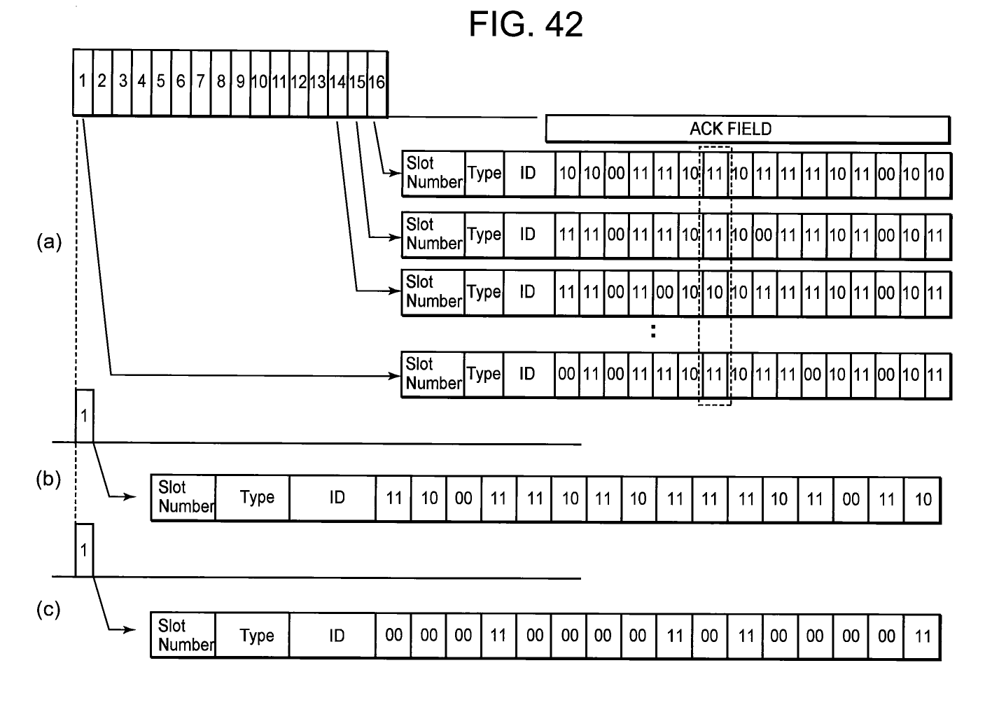

### BRIEF DESCRIPTION OF THE DRAWINGS

[FIG. 1] It is an explanatory diagram showing state transition in a radio communication method, a radio communication system, and a radio communication device according to the first invention.

[FIG. 2] It is an explanatory diagram showing a structure example of time slots in the first invention.

[FIG. 3] It is an explanatory diagram showing an example of a control message format in the first invention.

[FIG. 4] It is a flowchart for explaining the operation of a first embodiment when the radio communication device according to the first invention is a representative node candidate.

[FIG. 5] It is a flowchart for explaining the details of packet reception processing of FIG. 4.

[FIG. 6] It is a flowchart for explaining the operation of the first embodiment when the radio communication device according to the first invention is a normal node.

[FIG. 7] It is an explanatory diagram showing an operation example of the first embodiment of the first invention.

[FIG. 8] It is an explanatory diagram showing the operation example of the first embodiment of the first invention.

[FIG. 9] It is a flowchart for explaining the operation of a second embodiment when the radio communication device according to the first invention is a representative node candidate.

[FIG. 10] It is a flowchart for explaining the operation of the first embodiment when the radio communication device according to the first invention is a normal node.

[FIG. 11] It is an explanatory diagram showing an operation example of the second embodiment of the first invention.

[FIG. 12] It is an explanatory diagram showing the operation example of the second embodiment of the first invention.

[FIG. 13] It is a block diagram showing the first and second embodiments of the radio communication device according to the first invention.

[FIG. 14] It is an explanatory diagram showing, as one of conventional techniques, a procedure for detecting an empty time slot by CSMA/CA to perform transmission.

[FIG. 15] It is an explanatory diagram showing the structure of time slots in a radio communication method, a radio communication system, and a radio communication device according to the second invention.

[FIG. 16] It is an explanatory diagram showing the structure of a collision advertisement message in the second invention.

[FIG. 17] It is a flowchart for explaining the operation of a first embodiment of the radio communication device according to the second invention.

[FIG. 18] It is a flowchart for explaining the details of packet reception processing of FIG. 17.

[FIG. 19] It is a flowchart for explaining the details of extension control processing of FIG. 17.

[FIG. 20] It is an explanatory diagram showing an operation example of the first embodiment of the second invention.

[FIG. 21] It is a flowchart for explaining the operation of a second embodiment of the radio communication device according to the second invention.

[FIG. 22] It is a flowchart for explaining the details of packet reception processing of FIG. 21.

[FIG. 23] It is a flowchart for explaining the details of extension control processing of FIG. 21.

[FIG. 24] It is an explanatory diagram showing an operation example of the second embodiment of the second invention.

[FIG. 25] It is a block diagram showing the first and second embodiments of the radio communication device according to the second invention.

[FIG. 26] It is a diagram for explaining radio node classification and the structure of a system in an embodiment of the third invention.

[FIG. 27] It is an explanatory diagram showing a superframe period and the structure of time slots in the embodiment of the third invention.

[FIG. 28] It is an explanatory diagram showing an operation sequence of response confirmation in the embodiment of the third invention.

[FIG. 29] It is a block diagram showing the structure of a radio communication node in the embodiment of the third invention.

[FIG. 30] It is a block diagram showing the details of the configuration of a control section of FIG. 29.

[FIG. 31] It is an explanatory diagram showing the structure of a frame in the embodiment of the third invention.

[FIG. 32] It is a flowchart for explaining the operation of an ACK generation section in the embodiment of the third invention.

[FIG. 33] It is a flowchart for explaining the operation of a number of slots controlling section of FIG. 30.

[FIG. 34] It is an explanatory diagram showing the structure of a frame in an embodiment of the fourth invention.

[FIG. 35] It is an explanatory diagram showing ACK field generation timing in the embodiment of the fourth invention.

[FIG. 36] It is an explanatory diagram showing a response confirmation method using an ACK field in the embodiment of the fourth invention.

[FIG. 37] It is a block diagram showing the structure of a radio communication node in the embodiment of the fourth invention.

[FIG. 38] It is a block diagram showing in detail the configuration of a control section of the radio communication node in the embodiment of the fourth invention.

[FIG. 39] It is a flowchart for explaining processing in a congestion control section of FIG. 38.

[FIG. 40] It is a flowchart for explaining the details of stop-of-transmission determination processing of FIG. 39.

[FIG. 41] It is a flowchart for explaining the details of return-to-transmission determination processing of FIG. 39.

[FIG. 42] It is a diagram for explaining a sequence of control operations during congestion in the embodiment of the fourth invention.

[FIG. 43] It is a diagram for explaining the operation of receipt responses to unicast frames in a conventional system.

[FIG. 44] It is a diagram for explaining the operation of receipt responses to broadcast frames in the conventional system.

### BEST MODE FOR CARRYING OUT THE INVENTION

Embodiments of the present invention will be described below with reference to the drawings.

<First Invention>

FIG. 1 is an explanatory diagram showing state transition in a radio communication method, a radio communication system, and a radio communication device according to the first invention. FIG. 1(a) shows that Node 1 and Node 2 are located in a range communicable with each other, Node 2 and Node 3 are located in a range communicable with each other, and Node 1 and Node 3 are not located in a range communicable with each other. In this case, the state of Node 2 makes transition to a representative node (DesiGnated Node and hereinafter DGN) as shown in FIG. 1(b) in this invention. Here, the states of FIG. 1(a) and FIG. 1(b) are called Spare Mode and Dense Mode, respectively.

In the first invention, any period within a superframe of a constant cycle is defined as an active period and the rest is defined as a sleep (inactive) period, and the active period is divided into plural time slots (=0, 1, . . . , 7) as shown in FIG. 2. When each of plural radio communication devices (nodes) uses each time slot to perform time-division two-way communication, the first time slot=0 is defined as an administrative slot, and subsequent time slots=1 to 7 are defined as data transmission slots (=1 to 7) and control slots (=1-7), respectively. The administrative slot (=0) lets the DGN transmit a DGN advertisement message and allows a collision. The data transmission slots (=1-7) are selected at random by nodes (normal nodes), which did not become the DGN, to transmit data (packets). When receiving data in any of the data transmission slots (=1-7), the DGN transmits a confirmation message (ACK) in the immediately following control slot (=1-7). Further, the DGN selects a control slot (=1-7) at random to transmit a control packet.

FIG. 3 shows an example of a control message format, which consists of the kind of message (Type) and the node ID of each transmission source. Type indicates the following kinds of messages.

00: CDGN (Candidate for DGN, i.e., candidate for representative node) declaration message

01: DGN advertisement message

10: ACK

### First Embodiment of First Invention

FIG. 4 and FIG. 5 are flowcharts for explaining the operation of a candidate for a representative node (CDGN) according to a first embodiment. In FIG. 4, it is first judged whether transition to Dense Mode (DM) is made by CSMA/CD according to the time slot duty cycle (note that “time slot” is simply referred to as “slot” in the drawing) and the collision rate of time slots, and a node concerned becomes a CDGN (steps S1 and S2). If it does not become the CDGN, it makes transition to a normal node (step S3), and processing ends. On the other hand, if it is judged that the node becomes the CDGN, a CDGN declaration message is generated (step S4), and a control slot (=1-7) for transmitting the CDGN declaration message is decided (step S5). It is then judged whether the timing of the time slot is a control slot for transmitting the CDGN declaration message (step S6), and if so, the CDGN declaration message is transmitted (step S7). On the other hand, if not, reception processing shown in detail in FIG. 5 is performed (step S8). In the reception processing of step S8, as shown in detail in FIG. 5, it is judged whether a received packet is a CDGN declaration message (step S31), and if so, the CDGN declaration message is recorded (step S32). On the other hand, if not, the received packet is processed as a data packet (step S33).

Returning to FIG. 4, it is judged in step S9 whether it is the final slot (=7), and if not, processing returns to step S6. On the other hand, if so, processing proceeds to step S10, and a DGN is decided by a predetermined method (to be described later) from received (and transmitted) CDGN declaration messages. It is then judged whether its own node becomes the DGN (step S11). If it does not become the DGN, the CDGN makes transition to a normal node in Dense Mode (DM) (step S12), and processing ends. On the other hand, if it becomes the DGN, a DGN advertisement message is generated (step S13), and the DGN advertisement message is transmitted in time slot=0 of the next active period (step S14). It is then determined whether a data packet has been received (step S15), and if it has been received, an ACK is transmitted in the control slot in which the data packet was received (step S16). It is then determined whether it is the final time slot=7 (step S17). If not, processing returns to step S15, while if so, processing proceeds to step S18.

It is determined in step S18 whether no data packet has been received during the active period. If any data packet has been received, processing returns to step S14 to continue the operation as the DGN, while if not received, processing proceeds to step S19. In step S19, transmission of the DGN advertisement message is stopped during the next active period, and then, a time slot for transmitting a data packet during the next active period is decided (step S20). Since no data packet is transmitted from its own node during DM, a time slot for transmitting a data packet is decided in step S20. It is then determined whether it is the timing of the transmission time slot for its own node (step S21). If so, a data packet is transmitted (step S22), while if not, the reception processing shown in detail in FIG. 5 is performed (step S23). It is then determined whether it is the final time slot=7 (step S24). If not, processing returns to step S21, while if so, processing proceeds to step S25. In step S25, the priority of becoming a CDGN at the next opportunity to enter Dense Mode (DM) is reduced. Then, DM is terminated (step S26), and this processing ends.

Processing performed by a normal node will next be described with reference to FIG. 6. First, a time slot for transmitting a data packet is decided (step S41). It is then determined whether it is the timing of the time slot for its own node to transmit a data packet (step S42). If so, the data packet is transmitted (step S43), while if not, the reception processing shown in detail in FIG. 5 is performed (step S44). It is then determined whether it is the final time slot (step S45). If not, processing returns to step S42, while if so, processing proceeds to step S46.

It is determined in step S46 whether a CDGN declaration message has been received in a control slot. If not received, processing returns to step S41, while if received, a DGN (another node) is decided by a predetermined method (to be described later) from the received CDGN declaration message (step S47). After that, the state of the normal node makes transition from SM to DM. It is then determined whether data packet transmission is being stopped (step S48). If being stopped, the reception processing shown in detail in FIG. 5 is performed (step S49), and processing proceeds to step S56. On the other hand, if packet transmission is not being stopped in step S48, a time slot for transmitting a data packet is decided (step S50), and it is then determined whether the timing of the time slot is for its own node to transmit a data packet (step S51). If so, the data packet is transmitted (step S52), and it is then determined whether an ACK message has been received in a control slot (step S53). If so, transmission of the data packet is stopped (step S54), and processing proceeds to step S56. On the other hand, if no ACK message has been received in step S53, processing proceeds to step S56 without stopping transmission of the data packet. In step S51, if it is not the time slot for data packet transmission, the reception processing shown in detail in FIG. 5 is performed (step S55), and processing proceeds to step S56.

It is determined in step S56 whether it is the final time slot. If not, processing returns to step S48, while if so, processing proceeds to step S57. It is determined in step S57 whether a DGN advertisement message has been received in time slot=0 or a collision has been detected in time slot=0. If either of them is determined, processing returns to step S48 to continue DM, while if none of them is determined, data packet transmission is resumed (step S58), and processing returns to step S41. At this time, the normal node exits DM and its state makes transition to SM.

FIG. 7 and FIG. 8 show an example operation of nodes 1, 2, and 3 according to the first embodiment of the first invention. Here, due to limitations of space, FIG. 7 shows active periods AP1 and AP2, and FIG. 8 shows active periods AP3 and AP4.

<Active Period AP1>

(1) Node 1 that detected a collision during the previous active period and decided transition to CDGN transmits a CDGN declaration message in control slot=1 of active period AP1,

(2) node 3 that detected no collision during the previous active period transmits a data packet in data transmission slot=4 of active period AP1, and

(3) node 2 that detected a collision during the previous active period and decided transition to CDGN transmits a CDGN declaration message in control slot=7 of active period AP1.

(4)(5)(6) Nodes 1, 2, 3 select a representative node (DGN) by a predetermined method (for example, node having the smallest node ID) from received or transmitted CDGN declaration messages. Here, Node 1 having the smallest node ID is selected. Here, node 2 that have turned into CDGN makes transition to a normal node (steps S10 to S12 in FIG. 4). Hereinafter, node 1 that is the representative node during active periods AP2 to AP4 is described as “representative node 1.” Similarly, node 2 and node 3 as normal nodes without becoming the representative node are described as “normal node 2” and “normal node 3.”

<Active Period AP2>

(7) Representative node 1 transmits a DGN advertisement message in administrative slot=0 of active period AP2,

(8) normal node 2 transmits a data packet in data transmission slot=4 of active period AP2, and

(9) representative node 1 transmits an ACK in control slot=4 of active period AP2. Since receiving, in control slot=4, the ACK for the data packet transmitted in data transmission slot=4, normal node 2 stops data packet transmission during the next active period AP3 (steps S50 to S54 in FIG. 6).

(10) Normal node 3 receives this ACK (destined to node 2 though no destination address) but it discards the ACK because it has transmitted no data packet in the same data transmission slot=4.

(11) Normal node 3 transmits a data packet in data transmission slot=7 of active period AP2, and

(12) representative node 1 transmits an ACK in control slot=7 of active period AP2. Since receiving, in control slot=7, the ACK for the data packet transmitted in data transmission slot=7, normal node 3 stops data packet transmission during the next active period AP3 (steps S50 to S54 in FIG. 6).

(13) Normal node 2 receives this ACK (destined to node 3 through no destination address) but it discards the ACK because it has transmitted no data packet in the same data transmission slot=7.

<Active Period AP3>

(14)(15) After completion of active period AP2, representative node 1 judges in step S18 of FIG. 4 (judgment as to the presence of a data transmission node) whether DM should be maintained. In this case, it is judged that DM should be maintained because of the presence of a data transmission node during active period AP2, and a DGN advertisement message is transmitted in administrative slot=0 of the next active period AP3.

(16)(17) Since receiving the ACK during active period AP2 (Yes in step S53 of FIG. 6), normal nodes 2, 3 stop data packet transmission during the next active period AP3 (step S54 in FIG. 6). Further, since the DGN advertisement message was received in administrative slot=0 of active period AP2 (Yes in step S57 of FIG. 6), DM is maintained.

<Active Period AP4>

(18)(19) After completion of active period AP3, representative node 1 also judges in step S18 of FIG. 4 (judgment as to the presence of a data transmission node) whether DM should be maintained. In this case, it is judged that DM should not be maintained because no data transmission node is present during active period AP3, transmission of the DGN advertisement message is stopped during active period AP4 (step S19), and a data packet is transmitted from its own node in data transmission slot=2 of active period AP4.

(20)(21) Since normal nodes 2, 3 received the DGN advertisement message during active period AP3 (Yes in step S57 of FIG. 6), DM is maintained.

(22) The priority given to representative node 1 to become the CDGN at the next opportunity to enter Dense Mode (DM) is reduced (step S25 in FIG. 4), and representative node 1 starts data packet transmission from the next active period.

(23)(24) Since normal nodes 2, 3 received no DGN advertisement message during active period AP4, termination of DM is judged, and they start (resume) data packet transmission from the next active period.

### Second Embodiment of First Invention

FIG. 9 is a flowchart for explaining the operation of a candidate for a representative node (CDGN) according to a second embodiment of the first invention. In the second embodiment, the CDGN declaration message is transmitted in both the administrative slot (=0) and a control slot of the same active period. In FIG. 9, steps S101 to S104 are the same as steps S1 to S4, respectively, and their description will be omitted. In step S104, after generation of the CDGN declaration message, a time slot for transmitting a data packet is decided (step S105). Then, a control slot for transmitting the CDGN declaration message is decided (step S106), and the CDGN declaration message is transmitted in administrative slot=0 (step S107).

It is then determined whether it is the timing of the time slot for transmitting the data packet (step S108), and if so, processing proceeds to step S109. On the other hand, if not, processing proceeds to step S111 to perform the reception processing shown in detail in FIG. 5, and processing proceeds to step S112. In step S109, a data packet is transmitted, data packet transmission is stopped (step S110), and processing proceeds to step S112. In step S112, it is determined whether it is the timing of a control slot for transmitting the CDGN declaration message, and if so, the CDGN declaration message is transmitted (step S113). Then, processing proceeds to step S115. In step S112, if it is not the control slot for transmitting the CDGN declaration message, the reception processing shown in detail in FIG. 5 is performed, and processing proceeds to step S115. In step S115, it is determined whether it is the final time slot. If so, processing returns to step S108, while if not, processing proceeds to step S116.

In step S116, a DGN is decided from received (and transmitted) CDGN declaration messages, and if its own node becomes the DGN, a DGN advertisement message is generated (step S117 to step S118), and processing proceeds to step S120. In step S117, if its own node does not become the DGN, it makes transition from the CDGN to a normal node in Dense Mode (DM) (step S119), and processing ends. In step S120, the DGN advertisement message is transmitted in time slot=0, and it is then determined whether any data packet has been received (step S121). If received, an ACK is transmitted in a control slot immediately following the data transmission slot in which the data packet was received (step S122). It is then determined whether it is the final time slot (step S123). If not, processing returns to step S121, while if not, processing proceeds to step S124.

It is determined in step S124 whether the number of time slots that detect collisions decreases to a number smaller than a reference value. If not decrease, processing returns to step S120 to continue DM, while decreases, processing proceeds to step S125. In step S125, transmission of the DGN advertisement message is stopped during the next active period, and in step S126, the priority of becoming the CDGN at the next opportunity to enter DM is reduced. Then, this processing ends.

A second embodiment of the first invention will next be described with reference to FIG. 10. In FIG. 10, processing in steps S42-1 to S42-6 is different from processing in steps S42 to S44 shown in FIG. 6. First, a time slot for transmitting a data packet is decided (step S41). It is then determined whether CDGN declaration messages have been received or a collision has been detected in time slot=0 (step S42-1). If either of them is determined, processing proceeds to step S42-2, while if none of them is determined, processing branches to step S42-4. In step S42-2, data packet transmission is stopped, the reception processing shown in detail in FIG. 5 is performed (step S42-3), and processing proceeds to step S45. In step S42-4, it is determined whether it is the time slot for its own node to transmit a data packet. If so, the data packet is transmitted (step S42-5), and processing proceeds to step S45. On the other hand, if not, the reception processing shown in detail in FIG. 5 is performed (step S42-6), and processing proceeds to step S45. The presence of the CDGN declaration messages means that nodes are congested around its own node including a node that has detected the occurrence of a transmission collision. Therefore, the node judged to be Yes in step S42-1 immediately stops data packet transmission (step S42-2) to avoid causing the occurrence of a new transmission collision.

Processing in steps S45 to S47 is the same as that in FIG. 6, except for addition of step S47a between steps S47 and S48. In step S47, when a DGN is decided by a predetermined method from the received CDGN declaration messages, data packet transmission is resumed in step S47a, and processing proceeds to step S48. Processing in step S48 and subsequent steps is the same as that in FIG. 6, and its description will be omitted.

FIG. 11 and FIG. 12 show an example operation of nodes 1, 2, and 3 according to the second embodiment of the first invention. Similarly, due to limitations of space, FIG. 11 shows active periods AP1 and AP2, and FIG. 12 shows active periods AP3 and AP4.

<Active Period AP1>

(1) Node 1 that detected a collision during the previous active period and decided transition to CDGN transmits a CDGN declaration message in the administrative slot (=1) of active period AP1,

(2) node 2 that detected no collision during the previous active period and decided transition to CDGN also transmits a CDGN declaration message in the administrative slot (=1) of active period AP1, and

(3) node 3 that detected no collision during the previous active period detects a collision in the administrative slot (=0) of active period AP1.

(4) Node 1 transmits a data packet in data transmission slot (=4) of active period AP1,

(5) node 1 transmits a CDGN declaration message in control slot (=4) of active period AP1,

(6) node 2 transmits a data packet in data transmission slot (=6) of active period AP1, and

(7) node 2 transmits a CDGN declaration message in control slot (=6) of active period AP1.

(8)(9) Nodes 1 and 2 select a DGN (representative node) by a predetermined method (for example, node having the smallest node ID) from received or transmitted CDGN declaration messages. Here, Node 1 having the smallest node ID is selected as the DGN.

(10) Since detecting the collision in the administrative slot (=0) of active period AP1, node 3 stops packet transmission during active period AP1 (steps S42-1 to S42-2 in FIG. 10). Further, from the CDGN declaration messages received in control slots (=4, 6), a DGN is selected by a predetermined method (for example, node having the smallest node ID). Here, node 1 having the smallest node ID is selected as the DGN. Here, node 2 that made transition to the CDGN makes transition to normal node (steps S116 to S119 in FIG. 9). Hereinafter, node 1 that is the representative node during active periods AP2 to AP4 is described as “representative node 1.” Similarly, node 2 and node 3 as normal nodes without becoming the representative node are described as “normal node 2” and “normal node 3.”

<Active Period AP2>

(11) Representative node 1 transmits a DGN advertisement message in the administrative slot (=0) of active period AP2,

(12) normal node 2 transmits a data packet in the data transmission slot (=4) of active period AP2, and

(13) representative node 1 transmits an ACK in the control slot (=4) of active period AP2. Since receiving, in control slot=4, the ACK for the data packet transmitted in data transmission slot=4, normal node 2 stops data packet transmission during the next active period AP3 (steps S50 to S54 in FIG. 10).

(14) Normal node 3 receives this ACK (destined to node 2 though no destination address) but it discards the ACK because it has transmitted no data packet in the same data transmission slot=4.

(15) Normal node 3 transmits a data packet in data transmission slot (=7) of active period AP2, and

(16) representative node 1 transmits an ACK in control slot (=7) of active period AP2. Since receiving, in control slot=7, the ACK for the data packet transmitted in data transmission slot=7, normal node 3 stops data packet transmission during the next active period AP3 (steps S50 to S54 in FIG. 10).

(17) Normal node 2 receives this ACK (destined to node 3 through no destination address) but it discards the ACK because it has transmitted no data packet in the same data transmission slot=7.

(18) Representative node 1 judges, in steps S124 to S127 shown in FIG. 9, whether DM should be maintained. For example, if the number of collision detecting slots decreases, it judges termination of DM, and it stops transmission of the DGN advertisement message during the next active period AP3. Further, it resumes data packet transmission during the next active period AP3.

(19)(20) Since receiving the ACK, normal nodes 2 and 3 stop data packet transmission during DM. However, they resume data packet transmission when receiving of the DGN advertisement message ceases in the administrative slot (=0).

<Active Period AP3>

(21) Normal node 2 transmits a data packet in data transmission slot (=1) of active period AP3,

(22) normal node 1 transmits a data packet in data transmission slot (=3) of active period AP3, and

(23) normal node 3 transmits a data packet in data transmission slot (=6) of active period AP3.

(24) Normal node 1 reduces its priority of becoming the CDGM at the next opportunity to make transition to DM.

(25)(26) Since receiving no DGN advertisement message in administrative slot(=0) of active period AP3, normal nodes 2 and 3 resume data packet transmission and transmit data packets at (21) and (23), respectively.

FIG. 13 shows the structure of a radio communication device (node) 10 according to the first invention. Carriers on each time slot are received via a radio antenna 11, demodulated by radio receiving means 12, and applied to collision detection means 13, CDGN declaration message analyzing means 14, DGN advertisement message analyzing means 15, ACK analysis means 16, and data packet analyzing means 17. A collision among carriers on each time slot is detected by the collision detection means 13, and a slot 19a as a collision source is stored in information storage means 19. Further, a CDGN declaration message on each time slot is analyzed by the CDGN declaration message analyzing means 14, and the analyzed CDGN declaration message 19c is stored in the information storage means 19. In the information storage means 19, the number of slots 19b that have been used, a node ID 19d of its own node decided as a DGN, and priority 19e of making transition to a CDGN are also stored.

A DGN advertisement message, an ACK, and a data packet on each time slot are analyzed by the DGN advertisement message analyzing means 15, the ACK analysis means 16, and the data packet analyzing means 17, respectively. Based on the analyzed DGN advertisement message and ACK, stop of data packet transmission is judged by “stop of data packet transmission controlling means” 18. “Transition to CDGN judging means” 20 judges whether to make transition to the CDGN or reduces the “priority of making transition to the CDGN” 19e based on the collision source slot 19a and “the number of slots that have been used” 19b stored in the information storage means 19. “Transition to DGN judging means” 21 judges transition to the DGN based on the CDGN declaration message 19c stored in the information storage means 19.

When the “transition to DGN judging means” 21 judges to make transition to the DGN, “transmission of DGN advertisement message controlling means” 22 generates a DGN advertisement message, while when the “transition to DGN judging means” 20 judges to make transition to a CDGN, “transmission of CDGN declaration message controlling means” 23 generates a CDGN declaration message. Further, when the “stop of data packet transmission controlling means” 18 judges to stop data packet transmission, “data packet transmission controlling means” 24 stops data packet transmission, and “ACK transmission controlling means” 25 controls transmission of the ACK based on the data packet analyzed by the data packet analyzing means 17. Messages and the like generated by these transmission control means 22 to 25 are modulated by radio transmission means 26, and transmitted via the radio antenna 11.

<Second Invention>

Next, embodiments of the second invention will be described. FIG. 15 is an explanatory diagram showing the structure of time slots in a radio communication method, a radio communication system, and a radio communication device according to the second invention. In the second invention, any period within a superframe of a constant cycle is defined as an active period AP and the rest is defined as a sleep (inactive) period iAP, and the active period AP is divided into plural time slots. When each of plural radio communication devices (nodes) uses each time slot to perform time-division two-way communication, if each of the plural nodes detects a collision in each time slot, a collision advertisement message 201 is transmitted in a predetermined time slot (time slot=0 in FIG. 15) of the next active period AP, and the next active period AP is extended.

Further, a node that transmits a collision advertisement message 201 adds not only its own data but also a packet 202 including the collision advertisement message 201 (0, i, ii, and iii in FIG. 15) to an empty time slot (time slot=6 in FIG. 15) detected at random by CSMA during the next active period AP. Then, when detection of collisions in the extended active period AP ceases, the extended active period AP is returned to the original duration (reduction).

FIG. 16 is a diagram showing a format example of the collision advertisement message 201. The collision advertisement message 201 consists of Type indicative of the kind of message (for example, Type=1), a collision slot indicative of a time slot that caused a collision, and the number of times of continuous transmission of this collision advertisement message 201 (Report No.), and the field of the node ID of each transmission source. As an example, the field of collision slot is made up of the same number of bits as the number of time slots, representing a bit map, where the position of a time slot that caused a collision is bit=1 and the position of a time slot that caused no collision is bit=0. Thus, a node that has received the collision advertisement message 201 can know whether a collision has occurred in a time slot in which it transmitted data last time.

### First Embodiment of Second Invention

FIG. 17, FIG. 18, and FIG. 19 are flowcharts for explaining the operation of nodes according to the first embodiment. In FIG. 17, it is first determined whether packet transmission is being stopped (step S201). If being stopped, processing proceeds to step S202, while if not being stopped, processing branches to step S205. In step S202, packet reception processing shown in detail in FIG. 18 is performed, and it is then determined whether the time slot timing is for the final slot (step S203). If it is not the timing of the final time slot, processing returns to step S201, while if it is the timing of the final time slot, processing proceeds to S204 to perform extension control processing shown in detail in FIG. 19, and processing returns to step S201. Since the extension control processing is performed by using all the processing results of collisions detected in each time slot and collision advertisement messages 201 received in each time slot within one active period AP (step S204), judgment in step S203 is made.

Next, the packet reception processing in step S202 will be described with reference to FIG. 18. It is first determined whether a collision has been detected (step S231). If detected, processing proceeds to step S232, while if not detected, processing branches to step S235. In step S232, a time slot that detected a collision is recorded, and it is then determined whether the time slot is the first time slot (=0) of the current active period AP (step S233). Then, if it is time slot=0, the next active period AP is extended to a certain length (step S234), and processing ends. On the other hand, if it is not time slot=0, processing ends as is.

If no collision is detected in step S231, it is determined in step S235 whether the time slot is time slot=0. If it is time slot=0, processing proceeds to step S236, while if it is not time slot=0, processing branches to step S241. In step S236, it is determined whether the collision advertisement message 201 has been received. If received, processing proceeds to step S237, while if not received, processing ends as is. In step S237, the next active period AP is extended to the certain length, and it is then determined whether a collision of its own node that has occurred during the previous active period AP is described in the received collision advertisement message 201 (in the field of collision slots in FIG. 15) (step S238). If the collision occurrence is described, processing ends as is, while if not described, the number of active periods AP over which packet transmission is stopped is decided (step S239), packet transmission is stopped (step S240), and processing ends.

If the time slot is not time slot=0 in step S235, the data part of the received packet is processed in step S241, and it is then determined whether packet 2 including the collision advertisement message 201 has been received (step S242). If received, processing proceeds to step S243, while if not received, processing ends as is. In step S243, the next active period AP is extended to the certain length, and it is then determined whether a collision of its own node that has occurred during the previous active period AP is described in the received collision advertisement message 201 (in the field of collision slots in FIG. 15) (step S244). If the collision occurrence is described, processing ends as is, while if not described, the number of active periods AP over which packet transmission is stopped is decided (step S245), packet transmission is stopped (step S246), and processing ends.

Next, the extension control processing in step 204 will be described in detail with reference to FIG. 19. It is first judged by the packet reception processing (step 202) whether the next active period AP should be extended (step S251 and S252). If should be extended, processing proceeds to step S253, while if should not be extended, processing branches to step S255. In step S253, the collision advertisement message 201 is generated, the next active period AP is extended to the certain length (step S254), and processing ends. In step S255, the next active period AP is effected by the normal length, and it is determined whether the collision advertisement message 201 is being currently transmitted (step S256). If the collision advertisement message 201 is being transmitted, transmission of the collision advertisement message 201 is stopped (step S257), Report No. of the collision advertisement message 201 is set to 0 (step S258), and processing ends. If the collision advertisement message 201 is not being transmitted in step S256, processing ends as is.

Returning to FIG. 17, step S205 and subsequent steps will be described. If packet transmission is being stopped in step S201, it is determined whether the active period AP is currently extended (step S205). If extended, a time slot for transmitting a packet within the extended active period AP is decided (step S206), and processing proceeds to step S208. On the other hand, if the active period AP is not currently extended in step S205, a time slot for transmitting a packet within the active period AP that is not extended is decided (step S207), and processing proceeds to step S208.

In step S208, based on the processing in step S231 and S232 of FIG. 18, it is determined whether the collision advertisement message 201 should be transmitted. If should be transmitted, processing proceeds to step S209, while should not be transmitted, processing branches to step S218. In step S209, it is determined whether the timing of the time slot is time slot=0. If it is the timing of time slot=0, processing proceeds to step S210, while if it is not the timing of time slot=0, processing branches to step S12. In step S210, the collision advertisement message 201 is transmitted, 1 is added to the number of times of continuous transmission of the collision advertisement message (Report No.) (step S211), and processing proceeds to step S221.

If it is not the timing of time slot=0 in step S209, it is determined whether it is the timing of a transmission time slot for its own node (step S212). If so, processing proceeds to step S213, while if not, processing branches to step S217. In step S213, it is determined whether Report No.=1, and if so, the packet 202 including the collision advertisement message 201 and data is transmitted (step S214), 1 is added to Report No. (step S215), and processing proceeds to step S221. If it is not Report No.=1 in step S213, a packet including data is transmitted (step S216), and processing proceeds to step S221. In step S212, if it is not the timing of the transmission time slot for its own node, the packet reception processing shown in detail in FIG. 4 is performed (step S217), and processing proceeds to step S221.

In step S208, if the collision advertisement message 201 should not be transmitted, it is determined whether it is the timing of the transmission time slot for its own node (step S218). If so, a packet including data is transmitted (step S219), and processing proceeds to step S221. On the other hand, if it is not the timing of the transmission time slot for its own node, the packet reception processing shown in detail in FIG. 4 is performed (step S220), and processing proceeds to step S221. In step S221, it is determined whether it is the timing of the final time slot. If not, processing returns to step S208, while if so, processing proceeds to step S222, the extension control processing shown in detail in FIG. 19 is performed, and processing returns to step S201.

FIG. 20 shows an operation example of the first embodiment of the second invention. Illustrated is a case where the first active period AP1 has a normal length (time slots=0, 1, . . . , 7), and collisions among packets transmitted by peripheral nodes in time slots=1, 2, 3, 5 have been detected. In this case, in the reception processing shown in FIG. 18, time slots=1, 2, 3, 5 that detected collisions are recorded, and extension of the next active period AP2 to the certain length (time slots=0, 1, . . . , 15) is decided. Further, in the extension control processing shown in FIG. 19, the collision advertisement message 1 is generated, and the next active period AP2 is extended to the certain length (time slots=0, 1, . . . , 15).

During the next active period AP2, in the processing of steps S208 to S211 shown in FIG. 17, the collision advertisement message 1 is transmitted in time slot=0, and the packet 202 including the collision advertisement message 201 and data is transmitted in time slot=6. Then, when a collision has been detected during the next active period AP2, the collision advertisement message 201 is transmitted in time slot=0 of the next active period AP3 (time slots=0, 1, . . . , 15). Further, when no collision has been detected during this active period AP3, the next active period AP4 is returned to the original length (time slots=0, 1, . . . , 7), and transmission of the collision advertisement message 201 is stopped in time slot=0.

### Second Embodiment of Second Invention

In the first embodiment of the second invention, the next active period AP is extended when a collision has been detected. On the contrary, in the second embodiment of the second invention, the current active period AP is extended when a collision has been detected. The second embodiment of the second invention will be described with reference to FIGS. 21 to 24. In this embodiment, although the number of time slots within a normal active period AP and the number of time slots within an extended active period AP are expressed in specific figures as (time slots=0, 1, . . . , 7) and (time slots=0, 1, . . . , 15), respectively, this invention is not limited thereto. In FIG. 21, S205a is added between step S205 and step S206 shown in FIG. 17, step S209a is added between S209 and steps S210, S212, and processing in step S221a is different from step S221 shown in FIG. 17. As a result of judgment in step S205 as to whether the active period AP is currently extended, if being extended, processing proceeds to step S205a, and it is determined whether the transmission time slot is undecided. If undecided, processing proceeds to step S206, a time slot for transmitting a packet within the extended active period AP is decided, and processing proceeds step S208. On the other hand, if the transmission time slot is not undecided in step S205a, processing proceeds to step S208 as is.

Further, in step S209, it is determined whether the timing of the time slot is time slot=0. If it is not the timing of time slot=0, processing proceeds to step S209a to determine whether it is time slot=7 and the number of times of continuous transmission of the collision advertisement message (Report No.) is 0. If so, processing proceeds to step S210 to transmit the collision advertisement message 201, while if not, processing branches to step S212. Further, in processing step S221a, it is determined whether it is the final time slot (=6 or 15). If not, processing returns to step S208, while if so, processing proceeds to step S222. The other processing steps are the same as those in FIG. 17, and their description will be omitted. The reason why time slot=6 is cited in step S221 as the time slot judged to be the final time slot is that the first time slot 0 and the last time slot 7 in the normal active period length (time slots=0, 1, . . . , 7) are set as predetermined time slots used for transmission of the collision advertisement message.

In packet reception processing shown in FIG. 22, processing steps S234a, S237a, and S243a are different from steps S234, S237, and S243 shown in FIG. 18, respectively, in that the current active period AP is extended to the certain length (time slots=0 to 15). The other processing steps are the same as those in FIG. 18, and their description will be omitted. Further, in extension control processing shown in FIG. 23, processing step S254a is different from step S254 shown in FIG. 19, and steps S259, S260 are added after step S254a. In step S254a, the current active period AP is extended to the certain length (time slots=0 to 15), and it is then determined whether it is time slot=7 (step S259). If it is time slot=7, a packet transmission slot is decided within the extended part of the active period AP (step S260), and processing ends. On the other hand, if it is not time slot=7, processing ends as is. The other processing steps are the same as those in FIG. 19, and their description will be omitted.

FIG. 24 shows a case, where collisions among packets transmitted by peripheral nodes in time slots=1, 2, 3, 5 have been detected in the first length (time slots=0, 1, . . . , 7) of the first active period AP1, as an operation example of the second embodiment of the second invention. In this case, in the reception processing shown in FIG. 22, time slots=1, 2, 3, 5 that detected collisions in step S232 are recorded, and the current active period AP1 is extended in step S234a to the certain length (time slots=0, 1, . . . , 15). Then, the collision advertisement message 1 is transmitted in time slot=7 of the current extended active period AP1, and the packet 2 including the collision advertisement message 1 and data is transmitted in time slot=13. Then, if a collision has been detected during this active period AP1, the collision advertisement message 201 is transmitted in time slot=0 of the next active period AP2 (time slots=0, 1, . . . , 15), while if no collision has been detected during this active period AP2, the next active period AP3 is returned to the original length, and transmission of the collision advertisement message 1 is stopped in time slot=0.

FIG. 25 shows the structure of a radio communication device (node) 210 according to the second invention. Carriers on each time slot are received via a radio antenna 211, demodulated by radio reception means 212, and applied to collision detection means 213, receiving slot analyzing means 215, and collision advertisement message analyzing means 216. A collision among carriers on each time slot is detected by the collision detection means 213, and the detected slot 218a as a collision source is stored in information storage means 218. Further, a receiving slot on each time slot is analyzed by the receiving slot analyzing means 215, and the collision advertisement message 201 is analyzed by the collision advertisement message analyzing means 216. Based on the collision source slot 218a detected by the collision detection means 213, the receiving slot analyzed by the receiving slot analyzing means 215, and the collision advertisement message 201 analyzed by the collision advertisement message analyzing means 216, “extension of active period controlling means” 214 determines whether the active period should be extended, the length of the active period is decided, and the decided length 218c of this active period is stored in the information storage means 218. Further, based on the collision advertisement message 201 analyzed by the collision advertisement message analyzing means 216, “stop of packet transmission controlling means 217 decides a packet transmission stopping period 218b, and this decided packet transmission stopping period 218b is stored in the information storage means 218.

Based on the collision source slot 218a stored in the information storage means 218, the packet transmission stopping period 218b, and the active period length 218c, “data transmission slot deciding means” 219 decides a time slot for data transmission, and collision advertisement message generating means 221 generates the collision advertisement message 201. Transmission timing is so controlled that the generated collision advertisement message 201 is transmitted in the above-mentioned transmission time slots=0, 7 for the collision advertisement message 201 by means of “transmission of collision advertisement message controlling means” 222. Further, “packet including data generating means” 220 generates a “packet including data” in the time slot decided by the “data transmission slot deciding means” 219, and “the collision advertisement message 201 and the packet 202.” This “packet including data” and “the collision advertisement message 201 and the packet 202 including data” are modulated by radio transmission means 223 and transmitted via the radio antenna 211.

<Third Invention>

Next, an embodiment of the third invention will be described. FIG. 26 shows radio node classification and the structure of a system in this embodiment. This system is connected to an external wired/wireless network 301 (for example, the Internet), and consists of a gateway (GW) 302 communicable with the external network 301 and capable of supplying power such as commercial power supply, and small battery-operated RF tags 303a, 303b as radio communication nodes 303. The RF tags 303a, 303b, which can send and receive, comes ready to support two-way data exchange, and are called P2P (Point to Point) tags below. The P2P tags 303a, 303b are of two types, namely a P2P-S tag 303a as a (Stationary) P2P tag designed not to anticipate movement after installation and a P2P-M tag 303b as a (Mobile) P2P designed to involve movement such as to be carried by a person.

As shown in FIG. 26, each of the P2P tag 303a, 303b exchanges its ID in an adhoc manner with any of the P2P tags 303a, 303b located in its communicable range. Thus, the moving P2P-M tag 303b enables the P2P tags 303a, 303b to exchange and accumulate IDs on a reciprocal basis, and hence to keep historical records of one another's contact. This makes it possible to accumulate activity history of a certain person in the P2P-M tag 303b and a history of people who pass a certain point in the P2P-S tag 303a. For example, as a specific application example, a case is considered where a history of behavior of people and their way of contact with one another is acquired. In this case, GW2 is positioned in a place where commercial power supply is available, and a large number of P2P-S tags 303a are positioned in other places, so that a history of behavior of people who carry the P2P-M tags 303b and their way of contact can be acquired.

Further, in such an application that people just send and receive their IDs to keep a history of contact using their radio communication nodes 303, since there is no need for senders of information to identify receivers, each of the tags 303a, 303b has only to broadcast its ID and each of the tag 303a, 303b that has received it has only to accumulate it.

FIG. 27 shows the structure of a superframe period T_p in this embodiment. According to the third invention, as shown in FIG. 27(a), the superframe period T_p has an active period Tact during which the tags 303a, 303b as the radio communication nodes 303 exchange frames, and a sleep period (=T_p-Tact) during which radio blocks (to be described later in FIG. 29) of the tags 303a, 303b stop operating. The active period Tact consists of a variable number of time slots TS as shown in FIG. 27(b) (the number of time slots=16 in the drawing). Each moving tag 303b selects each time slot TS within the active period Tact periodically at random, and transmits its own information in a frame to the selected time slot TS.

Each node 303 has the active period Tact for frame transmission and reception, and the sleep period (=T_p-Tact) during which the radio block stops operating, thereby achieving first power saving. The active period Tact consists of a variable number of time slots, and each moving node 303 attempts periodic transmission of its own information by CSMA (Carrier Sense Multiple Access) to time slots within the active period Tact in order from the first time slot. Therefore, the time slots are used in order from the first one.

FIG. 28 shows a sequence of response confirmation (ACK) according to this invention. Indicated in FIG. 28 is such a state that three nodes, namely node A, node B, and node C, are broadcasting their frames F[A], F[B], and F[C], respectively. In the third invention, each node A-C exchanges and accumulates information when they pass each other, and transmits the accumulated information only to a specific node (GW2 in FIG. 26). Thus, since a frame received from a certain node is never transferred to another node, the broadcast frames F[A], F[B], and F[C] are sent and received only among the nodes A-C located in their communication range.

FIG. 28 shows such a state that each node A-C is transmitting its own information in frame F[A], F[B], or F[C] to a time slot TS selected at random in superframe period N−1. Note that node A and node C are located in places where they cannot directly communicate with each other in this example. It is assumed that frame F[A] transmitted by node A is successfully received by node B, frame F[B] transmitted by node B is successfully received by node A and node C, and frame F[C] transmitted by node C is successfully received by node B.

When nodes A, B, and C transmit their frames F[A:b], F[B:a,c], and F[C:b] during the next superframe period N, respectively, they transmit the frames by adding information on nodes received in the respective frames F[A:b], F[B:a,c], and F[C:b] during the previous superframe period N−1. This enables each node A, B, C to recognize, from ACK information attached in a frame of another node and coming together, that its own frame F[A], F[B], F[C] transmitted during the previous superframe period N−1 has been received. In addition, node B can also confirm reception at plural nodes A, C by receiving ACK information from node A and node C.

Use of such ACK information makes it possible not only to confirm that its own frame has been actually received, but also to indirectly understand how many nodes another node communicate with. This allows a moving node to know how many communicable nodes are in the vicinity of a correspondence node communicating with the moving node at present. The third invention uses such ACK information to set the number of time slots used for the next superframe period from the number of time slots received by itself during the superframe period and the number of nodes expected from the received frames.

The structure of a node 303 of the third invention will next be described with reference to FIG. 29. The node 303 of this invention consists of a radio block 311 having a transmitter section 311a and a receiver section 311b, a control section 312, an ID storage section 313, a clock 314, and a power supply section 315. The transmitter section 311a has the function of transmitting frame F including its ID by radio. In the node 303 of the third invention, the transmitter section 311a transmits frames by broadcasting its ID periodically. The receiver section 311b has the function of receiving frames including IDs transmitted by other nodes 303 in the same way.

The control section 312 has the function of controlling the operation of this node 303. The details of the function of the control section 312 will be described later with reference to FIG. 30. The ID accumulation section 313 has the function of accumulating IDs of other nodes 303 received at the receiver section 311b. When an ID is accumulated in the ID accumulation section 313, time information on that time may be recorded together with the ID. Its own ID information is also recorded. The clock 314 has the function of outputting clock signals for grasping timings for frame transmission in the transmitter section 311a and frame reception in the receiver section 311b. The power supply section 315 is a power supply built in the node 303 to make the node 303 communicable even if it moves to any place. For example, the power supply is a battery mounted in the case of the node 303.

Referring next to FIG. 30, the function of the control section 312 in the embodiment of this invention will be described. Specifically, the control section 312 consists of a time slot adjusting section 321, a frame analysis section 322, a frame generation section 323, an ACK generation section 324, and a number of slots controlling section 325. The time slot adjusting section 321 has not only the function of performing control of time slot synchronization including superframe period synchronization, but also the function of receiving frame F and transmitting, using CSMA, frame F generated for a possible time slot TS. The frame analysis section 322 has not only the function of analyzing the reception status in each time slot TS and notifying it to the ACK generation section 324 and the number of slots controlling section 325, but also the function of acquiring ID information from the received frame F and notifying it to the ID accumulation section 313.

The ACK generation section 324 generates, based on information from the frame analysis section 322, an ACK field to be added to frame F to be transmitted by itself next time. The number of slots controlling section 325 decides, based on the information from the frame analysis section 322, the number of time slots to be set in its own node for the next superframe period. Specifically, processing illustrated in a flowchart to be described later is performed. The frame generation section 323 generates frame F from its own ID, time slot information to be transmitted, and ACK field information notified from the ACK generation section 324.

FIG. 31 shows the structure of frame F exchanged among respective tags (nodes 303). Each node 303 generates frame F with a fixed length transmittable in one time slot TS. Specifically, frame F consists of fields each for the slot number of each time slot TS transmitted by itself, the type of node 303, its own ID number (ID), and an ACK field for notifying the reception status to the sender node in response to reception of frame F from another node. The third invention features that receipt response information on the frame received from another node 303 in another time slot TS is included in frame F for transmitting its own information. Specifically, the ACK field consists of fields indicative of respective time slots TS1-TS16 of a superframe SF specified in the system, and the reception status in each time slot TS1-TS16 is stored as ACK information.

Unlike a method, so-called passive ACK, for responding individually using a receiver node ID or transmitting a frame of the receiver node to notify reception, the third invention uses an ACK field with a fixed length for a given number of time slots to provide its own reception information at a time to all nodes as transmission sources received during the previous superframe period N−1. Therefore, 16×16 reception states are provided in one superframe period T_p. Further, each piece of information for each time slot in the ACK field contains two bits, and the status is indicated as follows.

00: no reception

10: reception with error

11: successful reception

“10: reception with error” includes a case where received frame F has been discarded due to a bit error or frame error, and a case where frame F was not able to be received correctly due to a collision. Thus, the reception status of fixed time slots is notified instead of using an ACK for each individual node, and this makes it possible to keep the frame length fixed for the number of ACKs, compared to the case of confirming responses to plural nodes using individual ID nodes. Further, notification can be made with very small amounts of information.

Further, in addition to the TS fields TS1-TS16 corresponding to the respective time slots, a special one-bit flag field (SP field) is added to this ACK field. Though the details will be described later, this field is set to ON (bit=1) when its own frame was not able to be transmitted in the set number of time slots.

Referring next to FIG. 32, a method of generating the ACK field in the ACK generation section 324 will be described. Based on the information from the frame analysis section 322, the ACK generation section 324 configures the settings on the above-mentioned two-bit TS fields TS1-TS16 for the respective time slots TS received during a superframe period (step S301). Thus, time slots TS transmitted and received are all described in corresponding TS fields TS1-TS16 including errors due to collisions or the like.

Further, when there was no opportunity for itself to transmit in respective slots until the end of a set superframe period because of CSMA and hence transmission was not able to be performed (No in step S302), the SP field is set to ON to indicate it (step S303). This corresponds to such a case that the node moves to an environment where it communicates with more nodes 303 and has no opportunity for itself to transmit because the number of nodes exceeds the number of time slots N set in the superframe period. In such a case, the node will inform other nodes of the shortage of time slots as well as the TS fields in the ACK field inserted in its own frame to indicate transmission and reception were performed by itself. For example, if there are a large number of frames F with their SP fields set to ON during reception, it means that such a number of nodes 303 had no communication opportunity and hence was not able to perform transmission.

Next, the operation of the number of slots controlling section 325 will be described. When a node has shifted or moved from an environment capable of communicating with a large number of nodes 303 to an environment where there are fewer nodes 303 around it, it is important to reduce the number of time slots N used for reception during a superframe period from the viewpoint of power saving. On the contrary, when the node has shifted or moved from an environment for communication with few nodes 303 to an environment where a large number of nodes 303 exist, it is important to increase the number of time slots N to an appropriate number in order to exchange data with more nodes 303. Thus, the number of slots controlling section 325 serves to autonomously set the number of time slots N in the superframe period in such a manner.

FIG. 33 is a flowchart showing processing in the number of slots controlling section 325. Based on the information from the ACK generation section 324, reception information on its own node 303 during a superframe period concerned is grasped to check the time slot conditions in the superframe period. Then, candidates for the number of time slots N of the next superframe period are determined from this information. They are added up in such a manner that 1 is added to each of frames that were its own transmission and successful reception (=11), and 2 is added to states of error reception (=10) due to collisions or the like. The reason why 2 is added to the states of error reception (=10) is to take into account the presence of plural nodes that could be subjected to collisions. However, if there is no frame received, i.e., when the ACK generation section 324 has only the frame information transmitted by itself, the number of time slots N for the next superframe period is set to two slots in case of reception from another node to its transmission time slot.

When frame reception was performed, the number of time slots is added up in the same manner from the ACK field in the frame F that was successful reception(=11) based on the information from the frame analysis section 322 to determine candidates for the number of time slots N of the next superframe period. Among the candidates for the number of time slots thus determined, the maximum value is set as the number of basic time slots N during the next superframe period (step S311).

Next, the number of frames A set by the SP field in the ACK field of a successfully received frame is added to the number of basic time slots N (step S312). Therefore, the number of time slots N for the next superframe period is N+A. Thus, the number of frames A set by the SP field is added to the number of basic time slots N to set the number of time slots N=N+A for the next superframe period, and this increases the number of time slots N by the number of nodes 303, A, which were not be able to transmit. The status of the SP field in the ACK field generated by its own node 303 is also included therein (steps S313 and S314). Thus, the node 303 that has shifted to the environment where there are a large number of nodes 303 has other nodes 303 increase the number of time slots N by the number of nodes 303 that were not able to transmit, increasing the possibility of being received.

Thus, the number of time slots N is increased or decreased based not only on its own reception status, but also on the ACK information from other nodes. This makes it possible to achieve power saving while using time slots efficiently. Further, the SP field is provided in the ACK field to grasp the number of nodes that were not able to transmit during the previous superframe period. This makes it possible to grasp the shortage of time slots and to increase the number of time slots in one go.

<Fourth Invention>

Since the classification of radio communication devices (nodes) and the structure of a system in an embodiment of the fourth invention are the same as those in FIG. 26 according to the third invention, their description will be omitted. Further, since the structure of the superframe period T_p in the embodiment of the fourth invention is also the same as that in FIG. 27 according to the third invention, its description will also be omitted. In addition, since the sequence of response confirmation (ACK) in the embodiment of the fourth invention is also the same as that in FIG. 28 according to the third invention, its description will be omitted as well.

FIG. 34 shows the structure of frame F exchanged among respective tags (nodes 303). Each node 303 generates frame F with a fixed length transmittable in one time slot TS. Specifically, frame F consists of fields each for the slot number of each time slot TS transmitted by itself, the type of node 303, its own ID number (ID), and an ACK field for notifying the reception status to the sender node in response to reception of frame F from another node. The fourth invention features that receipt response information on the frame received from another node 303 in another time slot TS is included in frame F for transmitting its own information. Specifically, the ACK field consists of fields indicative of respective time slots TS1-TS16 of a superframe SF specified in the system, and the reception status in each time slot TS1-TS16 is stored as ACK information.

Unlike a method, so-called passive ACK, for responding individually using a sender node ID or transmitting a frame of the sender node to notify reception, the fourth invention also uses the ACK field with a fixed length for a given number of time slots to provide its own reception information at a time to all nodes as transmission sources received during the previous superframe period N−1. Therefore, 16×16 reception states are provided in one superframe period T_p. Further, each piece of information for each time slot in the ACK field contains two bits, and the status is indicated as follows.

00: no reception

10: reception with error

11: successful reception

“10: reception with error” includes a case where received frame F has been discarded due to a bit error or frame error, and a case where frame F was not able to be received correctly due to a collision. Thus, the reception status of fixed time slots is notified instead of using an ACK specifying each individual node, and this makes it possible to keep the frame length fixed for the number of ACKs, compared to the case of confirming responses to plural nodes using individual ID nodes. Further, notification can be made with very small amounts of information.

Referring next to FIG. 35, a method of generating the ACK field will be described. FIG. 35 illustrates the method of generating the ACK field using two timings of superframe periods N−1 and N for a certain node 303, assuming a case where the node 303 transmits frame F in “time slot:3” during the N-th superframe period. In the ACK field of frame F transmitted by the node 303 at this time, states of all time slots received by itself during the previous superframe period N−1 are described per time slot. For example, they are expressed as follow:
frame received successfully in “time slot:1” (hereinafter referred to as TS1) (=11),
frame received as well in TS2 (=11),
no frame reception in TS3 (=00),
. . .
frame received in TS6 but could not be completed correctly (=10), . . . .
   Thus, the reception state of each time slot during the previous superframe period N−1 is always notified to the node 303 during the superframe period N.

FIG. 36 shows a confirmation method using the ACK field upon superframe reception. After completion of reception during one superframe period N (all time slots TS=all frames), the reception status of time slots of each node 303 during the previous superframe period N−1 can be grasped from frame F received successfully. Each node 303 holds the slot number used by itself to broadcast during the previous superframe period N−1 to check a corresponding TS portion (TS7 in FIG. 36) of the ACK field, and this makes it possible to know the reception status of the previous frame F transmitted by itself and received by other nodes 303. Considering that the node 303 moves, reception information on frame F transmitted by another node 303 could be included. However, the ID of the node 303 that transmitted the information can be checked at the same time. In such a case, for example, if it is information from a new node other than the node received by itself during the previous superframe period N−1, it can be considered that the node concerned leaves the ACK information out.

The outline of the structure of the node 303 of the fourth invention shown in FIG. 37 is the same as that of the third invention in FIG. 29, except for the control section 312. The function of a control section 312a of the fourth invention will be described with reference to FIG. 37. The ID accumulation section 313 has the function of accumulating IDs of other nodes 303 received at the receiver section 311b. When an ID is accumulated in the ID accumulation section 313, time information on that time may be recorded together with the ID. Its own ID information is also recorded. The clock 314 has the function of outputting clock signals for grasping timings for frame transmission in the transmitter section 311a and frame reception in the receiver section 311b. The power supply section 315 is a power supply built in the node 303 to make the node 303 movable to any place. For example, the power supply is a battery mounted in the case of the node 303.

Referring next to FIG. 38, the function of a control section 312a in the embodiment of the fourth invention will be described. Specifically, the control section 312a consists of the time slot adjusting section 321, the frame analysis section 322, the frame generation section 323, the ACK generation section 324, and a congestion control section 325a. The time slot adjusting section 321 has not only the function of performing control of time slot synchronization including superframe period synchronization, but also the function of receiving frame F and transmitting frame F to a time slot TS selected at random. The frame analysis section 322 has not only the function of analyzing the reception status in each time slot TS and notifying it to the ACK generation section 324 and the congestion control section 325a, but also the function of acquiring ID information from the received frame F and notifying it to the ID accumulation section 313.

The ACK generation section 324 generates, based on information from the frame analysis section 322, an ACK field to be added to frame F to be transmitted by itself next time. The congestion control section 325a makes a judgment on congestion based on information from the frame analysis section 322 to make the frame generation section 323 and the time slot adjusting section 321 effectuate the result of determination to stop frame transmission or resume frame transmission. To be specific, processing illustrated in a flowchart to be described later is performed. The frame generation section 323 generates frame F from its own ID, time slot information to be transmitted, and ACK field information notified from the ACK generation section 324.

Next, an operation at the time of congestion will be described. When a large number of nodes 303 are congested within a radio communication range, such as when a person holding a node 303 is waiting for a signal at a traffic intersection, the number of time slots in a superframe period could become smaller than the number of node communicable in the communication range. In such a case, even if access control by CSMA (Carrier Sense Multiple Access) is performed, some nodes 303 may not be able to receive frames due to a collision, or some nodes 303 can have transmission opportunities continuously but the others may not be able to have the transmission opportunity repeatedly depending on the timing to make them unable to transmit frames. In this invention, the number of nodes 303 to transmit frame F during occurrence of congestion is reduced to avoid the congestion. This requires each node 303 to control the timing of stopping transmission of frame F and the timing of resuming transmission during congestion.

FIG. 39 to FIG. 41 are flowcharts showing processing in the congestion control section 325a. First, as shown in FIG. 39, if it is operating in a reduced time slot mode during congestion as a result of the information from the frame analysis section 322 (Yes in step S401), the congestion control section 325a performs return-to-transmission determination processing (step S402), while if it is operating in a normal time slot mode (No in step S401), the congestion control section 325a performs stop-of-transmission determination processing (step S403).

Referring to FIG. 40, the stop-of-transmission determination processing (step S403) will be described in detail. Upon completion of reception in one superframe n, it is determined whether the number of time slots that its own node 303 performed successful reception (=11) and error reception (=10) during the superframe n exceeds a congestion threshold value A (step S411). If it does not exceed the congestion threshold value A (No in step S411), it is determined not to be in a congestion state yet, and a normal operation is performed.

If it exceeds the congestion threshold value A (Yes in step S411), the ACK field of frame F that was successful reception (=11) is checked to determine whether the number of slots used by its own node and other nodes indicated by the ACK field exceeds a congestion threshold value B (step S412). If it does not exceed the congestion threshold value B (No in step S412), congestion is not determined yet because it may be a set of nodes 303 temporarily gathering when they pass each other, and normal frame transmission is performed.

If it exceeds the congestion threshold value B (Yes in step S412), the number of successful receptions (=11) for time slots in which itself transmitted during the previous superframe period is checked in the same manner from the ACK fields of all frames that were successful reception (=11) (step S413). If the number of receptions equal to or more than a threshold value C is confirmed (Yes in step S413), frame transmission during the next superframe is stopped (step S414), and the mode is changed to a reduced time slot operation mode in which the time slots that construct a superframe are reduced (step S415). If the number of receptions equal to or more than a threshold value C is not confirmed (No in step S413), normal frame transmission is performed to exchange its information though it is in a congestion state.

The reduced time slot operation mode is to reduce the number of time slots for reception in order to reduce power consumption when the node itself stops transmission during congestion until the congestion is avoided. The congestion state means that nodes have many correspondence partners to exchange information with each other, i.e., it means that the number of nodes that exchange and accumulate information on a certain node 303 increases. Further, in such a situation that nodes 303 densely gather together, it is conceivable that there is relatively less movement of nodes 303, and hence that transmission and reception between the same pair of nodes 303 increase if the congestion state persists. Therefore, the reduction of information to be received by and accumulated in a node 303, which has stopped its frame transmission in the congestion state, until elimination of the congestion state is effective means for radio nodes to which power saving is an important challenge.

Referring next to FIG. 41, the return-to-transmission determination processing when it is operating in the reduced time slot operation mode after transmission is stopped (step S402) will be described in detail. In the reduced time slot mode, the ACK field of frame F first received is used to determine a congestion state of the surroundings. If the number of slots used, which is indicated by the ACK field of frame F that was the first successful reception (=11), is equal to or less than a congestion threshold value D (Yes in step S421), it is determined that the congestion state has been avoided. Therefore, transmission of its frame F is resumed from the next superframe period (step S422), and the mode is changed to the normal time slot operation mode (step S423). If it is not equal to or less than the congestion threshold value D (No in step S421), it is determined to remain in the congestion state. Therefore, the mode enters a sleep mode without using subsequent time slots, and the same processing is repeated in the next superframe.

FIG. 42 shows an example of the reception status of each time slot. In FIG. 42(a), as described with reference to FIG. 36, each of the nodes 303 first transmits frame F including the ACK field as response information (no reception: 00, successful reception: 11, error reception: 10) to frames received from other nodes 303. FIG. 42(b) shows that the number of time slots used (successful reception: 11, error reception: 10) is high. When each node determines this and stops transmission, the number of time slots used (successful reception: 11, error reception: 10) is reduced, allowing each node 303 to determine this and resume transmission.

Since the elimination of congestion is thus determined, the state of congestion can be determined in a shorter operating time by using information of the ACK field included in certain reception frame F, rather than by receiving all times slots to check the number of time slots used, thereby making it possible to achieve power saving during congestion.

Note that each of the functional blocks used in describing the aforementioned embodiments is implemented as an LSI (Large Scale Integration) typified by an integrated circuit. Each of them may be made up of one chip individually, or they may be made up of one chip to include some or all of them. Here, although the LSI is assumed, it may be called an IC (Integrated Circuit), a system LSI, a super LSI, or an ultra LSI depending on the degree of integration. Further, the technique for creation of an integrated circuit is not limited to LSI, and it may be implemented by a private circuit or a general-purpose processor. An FPGA (Field Programmable Gate Array) capable of programming after LSI manufacturing or a reconfigurable processor capable of reconfiguring connections or settings of circuit cells within the LSI may also be employed. In addition, if integrated circuit technology capable of replacing LSI emerges with development of semiconductor technology or another technology derived therefrom, the technology may be used to integrate the functional blocks. For example, applications of biotechnology may be possible.

### INDUSTRIAL APPLICABILITY

The first invention has the effect of making it possible to prevent a collision in such a state that radio communication devices are congested, and is applicable to other network devices as well as the small battery-powered node for the radio communication network, especially for the electronic tag system in which small data is exchanged.

The second invention has the effects of making it possible to autonomously increase the opportunity of transmission when a collision occurs in such a state that radio communication devices are congested, and making it possible to increase the number of nodes that stop transmission in order to reduce the number of nodes that attempt transmission at a time. The second invention is applicable to other network devices as well as the small battery-powered node for the radio communication network, especially for the electronic tag system in which small data is exchanged.

The third invention has the effect of making it possible to operate with an appropriate number of time slots in radio communication for advertising its own information to an unspecified number of radio communication devices that involve movement, and hence to achieve power saving. The third invention is applicable to other network devices as well as the small battery-powered node for the radio communication network, especially for the electronic tag system in which small data is exchanged.

The fourth invention has the effect of making it possible to autonomously stop transmission using response confirmation in radio communication for advertising its own information to an unspecified number of radio communication devices that involve movement without increasing congestion during congestion, and to autonomously determine the elimination of a congestion state so as to resume transmission. The fourth invention is applicable to other network devices as well as the small battery-powered node for the radio communication network, especially for the electronic tag system in which small data is exchanged.

1. A radio communication method, in which any period within a superframe of a constant cycle is defined as an active period and rest is defined as a sleep period, and the active period is divided into plural time slots to enable each of plural radio communication devices to perform time-division two-way communication using each time slot, the method comprising:
a step of allowing each of the plural radio communication devices to detect, based on a communication condition in each time slot, such a state that plural radio communication devices are congested, and to decide one of the plural radio communication devices as a representative node;
a step of allowing a first radio communication device decided as the representative node to transmit a representative node advertisement message advertising that the first radio communication device becomes the representative node;
a step of allowing a second radio communication device, which has not been decided as the representative node, to transmit a data packet when receiving the representative node advertisement message;
a step of allowing the first radio communication device to transmit a confirmation message when receiving the data packet after transmitting the representative node advertisement message; and
a step of allowing the second radio communication device to stop data packet transmission during an immediately following active period when receiving the confirmation message after transmitting the data packet.

2. The radio communication method according to claim 1 further comprising:
a step of allowing the first radio communication device to stop transmission of the representative node advertisement message during the immediately following active period when not receiving the data packet after transmitting the confirmation message or when the number of collision detecting time slots is equal to or less than a reference value; and
a step of allowing the second radio communication device to resume data packet transmission during the immediately following active period when not receiving the representative node advertisement message after stopping the data packet transmission.

3. The radio communication method according to claim 1, wherein when the representative node is decided, each of the plural radio communication device detects, based on the communication condition in each time slot, such a state that plural radio communication devices are congested, and transmits, during the immediately following active period, a representative node candidate declaration message declaring that the radio communication device becomes a representative node candidate, and each of plural radio communication devices that have received and transmitted the representative node candidate declaration message decides, based on a predetermined method, one of the plural radio communication devices as the representative node.

4. The radio communication method according to claim 3, wherein when the first radio communication device decided as the representative node stops transmission of the representative node advertisement message, priority of becoming a representative node candidate next time is reduced.

5. A radio communication system, in which any period within a superframe of a constant cycle is defined as an active period and rest is defined as a sleep period, and the active period is divided into plural time slots to enable each of plural radio communication devices to perform time-division two-way communication using each time slot, the system comprising:
means for allowing each of the plural radio communication devices to detect, based on a communication condition in each time slot, such a state that plural radio communication devices are congested, and to decide one of the plural radio communication devices as a representative node;
means for allowing a first radio communication device decided as the representative node to transmit a representative node advertisement message advertising that the first radio communication device becomes the representative node;
means for allowing a second radio communication device, which has not been decided as the representative node, to transmit a data packet when receiving the representative node advertisement message;
means for allowing the first radio communication device to transmit a confirmation message when receiving the data packet after transmitting the representative node advertisement message; and
means for allowing the second radio communication device to stop data packet transmission during an immediately following active period when receiving the confirmation message after transmitting the data packet.

6. The radio communication system according to claim 5 further comprising:
means for allowing the first radio communication device to stop transmission of the representative node advertisement message during the immediately following active period when not receiving the data packet after transmitting the confirmation message or when the number of collision detecting time slots is equal to or less than a reference value; and
means for allowing the second radio communication device to resume data packet transmission during the immediately following active period when not receiving the representative node advertisement message after stopping data packet transmission.

7. The radio communication system according to claim 5, wherein when the representative node is decided, each of the plural radio communication device detects, based on the communication condition in each time slot, such a state that plural radio communication devices are congested, and transmits, during the immediately following active period, a representative node candidate declaration message declaring that the radio communication device becomes a representative node candidate, and each of plural radio communication devices that have received and transmitted the representative node candidate declaration message decides, based on a predetermined method, one of the plural radio communication devices as the representative node.

8. The radio communication system according to claim 7, wherein when the first radio communication device decided as the representative node stops transmission of the representative node advertisement message, priority of becoming a representative node candidate next time is reduced.

9. A radio communication device in a communication system, in which any period within a superframe of a constant cycle is defined as an active period and rest is defined as a sleep period, and the active period is divided into plural time slots to enable each of plural radio communication device to perform time-division two-way communication using each time slot, the device comprising:
means for detecting, based on a communication condition in each time slot, such a state that plural radio communication devices are congested, and deciding one of the plural radio communication device as a representative node;
means for transmitting a representative node advertisement message advertising that the radio communication device becomes the representative node when having been decided as the representative node, and transmitting a confirmation message when receiving a data packet after transmitting the representative node advertisement message; and
means which, if having not been decided as the representative node, transmits a data packet when receiving the representative node advertisement message, and stops data packet transmission during an immediately following active period when receiving the confirmation message after transmitting the data packet.

10. The radio communication device according to claim 9 further comprising:
means for stopping transmission of the representative node advertisement message during the immediately following active period when not receiving the data packet after transmitting the confirmation message or when the number of collision detecting time slots is equal to or less than a reference value; and
means for resuming data packet transmission during the immediately following active period when not receiving the representative node advertisement message after transmitting the data packet.

11. The radio communication device according to claim 9 wherein when the representative node is decided, such a state that plural radio communication devices are congested is detected based on a communication condition in each time slot, a representative node candidate declaration message declaring that the radio communication device becomes a representative node candidate is transmitted during the immediately following active period, the representative node candidate declaration message is received, and based on a predetermined method, one of the plural radio communication devices is decided as the representative node.

12. The radio communication device according to claim 11, wherein when the radio communication device decided as the representative node stops transmission of the representative node advertisement message, priority of becoming a representative node candidate next time is reduced.

13. A radio communication method, in which any period within a superframe of a constant cycle is defined as an active period and rest is defined as a sleep period, and the active period is divided into plural time slots to enable each of plural radio communication devices to perform time-division two-way communication using each time slot, the method comprising:
a step of allowing each of the plural radio communication devices to detect a collision in each time slot; and
a step of allowing each of the plural radio communication device not only to transmit a collision advertisement message to a predetermined time slot of the plural time slots of an immediately following active period but also to extend the immediately following active period when the radio communication device has detected the collision.

14. A radio communication method, in which any period within a superframe of a constant cycle is defined as an active period and rest is defined as a sleep period, and the active period is divided into plural time slots to enable each of plural radio communication devices to perform time-division two-way communication using each time slot, the method comprising:
a step of allowing each of the plural radio communication device to detect a collision in each time slot; and
a step of allowing each of the plural radio communication device not only to extend a current active period but also to transmit a collision advertisement message to a predetermined time slot of the current active period when the radio communication device has detected the collision.

15. The radio communication method according to claim 13, wherein the radio communication device that has detected the collision transmits the collision advertisement message together with data to another time slot for transmitting the data during the current active period as well as to the predetermined time slot.

16. The radio communication method according to claim 13, wherein the collision advertisement message includes time slot identification information indicative of the time slot that has detected the collision, and
each of the plural radio communication devices that has received the collision advertisement message stops next transmission when a time slot transmitted by the radio communication device last time does not match the time slot identification information in the collision advertisement message.

17. A radio communication system, in which any period within a superframe of a constant cycle is defined as an active period and rest is defined as a sleep period, and the active period is divided into plural time slots to enable each of plural radio communication devices to perform time-division two-way communication using each time slot, the system comprising:
means for allowing each of the plural radio communication device to detect a collision in each time slot; and
means for allowing each of the plural radio communication device not only to transmit a collision advertisement message to a predetermined time slot of the plural time slots of an immediately following active period but also to extend the immediately following active period when the radio communication device has detected the collision.

18. A radio communication system, in which any period within a superframe of a constant cycle is defined as an active period and rest is defined as a sleep period, and the active period is divided into plural time slots to enable each of plural radio communication devices to perform time-division two-way communication using each time slot, the system comprising:
means for allowing each of the plural radio communication device to detect a collision in each time slot; and
means for allowing each of the plural radio communication device not only to extend a current active period but also to transmit a collision advertisement message to a predetermined time slot of the current active period when the radio communication device has detected the collision.

19. The radio communication system according to claim 17, wherein the radio communication device that has detected the collision transmits the collision advertisement message together with data to another time slot for transmitting the data during the current active period as well as to the predetermined time slot.

20. The radio communication system according to claim 17, wherein
the collision advertisement message includes time slot identification information indicative of the time slot that has detected the collision, and
each of the plural radio communication devices that has received the collision advertisement message stops next transmission when a time slot transmitted by the radio communication device last time does not match the time slot identification information in the collision advertisement message.

21. A radio communication device in a radio communication system, in which any period within a superframe of a constant cycle is defined as an active period and rest is defined as a sleep period, and the active period is divided into plural time slots to enable each of plural radio communication devices to perform time-division two-way communication using each time slot, the device comprising:
means for detecting a collision in each time slot; and
means for not only transmitting a collision advertisement message to a predetermined time slot of the plural time slots of an immediately following active period but also extending the immediately following active period when the radio communication device has detected the collision.

22. A radio communication device in a radio communication system, in which any period within a superframe of a constant cycle is defined as an active period and rest is defined as a sleep period, and the active period is divided into plural time slots to enable each of plural radio communication devices to perform time-division two-way communication using each time slot, the device comprising:
means for detecting a collision in each time slot; and
means for not only extending a current active period but also transmitting a collision advertisement message to a predetermined time slot of the current active period when the radio communication device has detected the collision.

23. The radio communication device according to claim 21, wherein the radio communication device that has detected the collision transmits the collision advertisement message together with data to another time slot for transmitting the data during the current active period as well as to the predetermined time slot.

24. The radio communication device according to claim 21, wherein
the collision advertisement message includes time slot identification information indicative of the time slot that has detected the collision, and
each of the plural radio communication devices that has received the collision advertisement message stops next transmission when a time slot transmitted by the radio communication device last time does not match the time slot identification information in the collision advertisement message.

25. A radio communication method, in which any period within a superframe of a constant cycle is defined as an active period and rest is defined as a sleep period, and the active period is divided into plural time slots to enable each of plural radio communication devices to perform time-division two-way communication using each time slot, the method comprising:
a step of allowing each of the plural radio communication devices to transmit a frame including a field of receipt response information on a frame received from another radio communication device in each of the plural time slots during each time slot period; and
a step of allowing each of the plural radio communication devices that have received the frame to increase or decrease the number of time slots used by own device during an immediately following superframe period based on each piece of receipt response information in the field of the receipt response information within an immediately preceding superframe period.

26. The radio communication method according to claim 25, wherein
when each of the plural radio communication devices was not able to transmit a frame, own device further transmits, in a frame to be transmitted next, a flag indicating that own device was not able to transmit the frame, and
each of the plural radio communication devices that have received the frame increases the number of time slots used by own device by the number of flags within the frame.

27. A radio communication system, in which any period within a superframe of a constant cycle is defined as an active period and rest is defined as a sleep period, and the active period is divided into plural time slots to enable each of plural radio communication devices to perform time-division two-way communication using each time slot, the system comprising:
means for allowing each of the plural radio communication devices to transmit a frame including a field of receipt response information on a frame received from another radio communication device in each of the plural time slots during each time slot period; and
means for allowing each of the plural radio communication devices that have received the frame to increase or decrease the number of time slots used by own device during an immediately following superframe period based on each piece of receipt response information in the field of the receipt response information within an immediately preceding superframe period.

28. The radio communication system according to claim 27, wherein
when each of the plural radio communication devices was not able to transmit a frame, own device further transmits, in a frame to be transmitted next, a flag indicating that own device was not able to transmit the frame, and
each of the plural radio communication devices that have received the frame increases the number of time slots used by own device by the number of flags within the frame.

29. A radio communication device in a radio communication system, in which any period within a superframe of a constant cycle is defined as an active period and rest is defined as a sleep period, and the active period is divided into plural time slots to enable each of plural radio communication devices to perform time-division two-way communication using each time slot, the device comprising:
means for transmitting a frame including a field of receipt response information on a frame received from another radio communication device in each of the plural time slots during each time slot period; and
means which, when having received the frame, increases or decreases the number of time slots used by own device during an immediately following superframe period based on each piece of receipt response information in the field of the receipt response information within an immediately preceding superframe period.

30. The radio communication device according to claim 29 further comprising:
means which, when own device was not able to transmit a frame, transmits, in a frame to be transmitted next, a flag indicating that own device was not able to transmit the frame, and
means which, when having received the frame, increases the number of time slots used by own device by the number of flags within the frame.

31. The radio communication method according to claim 25, wherein when the receipt response information contains error information, the number of time slots used is increased by the number of pieces of error information.

32. A congestion control method in a radio communication system, in which any period within a superframe of a constant cycle is defined as an active period and rest is defined as a sleep period, and the active period is divided into plural time slots to enable each of plural radio communication devices to perform time-division two-way communication using each time slot, the method comprising:
a step of allowing each of the plural radio communication devices to transmit a frame including a field of receipt response information on a frame received from another radio communication device in each of the plural time slots during each time slot period; and
a step of allowing each of the plural radio communication devices that have received the frame to determine whether to stop transmission of own device during an immediately following superframe period based on each piece of receipt response information in the field of the receipt response information within an immediately preceding superframe period.

33. The congestion control method according to claim 32, wherein
the receipt response information consists of information indicative of “no reception,” “successful reception,” or “error reception,” and
in the determination step, it is determined whether the total number of pieces of information of “successful reception” and “error reception” in the field of the receipt response information within the immediately preceding superframe period exceeds a first threshold value to determine whether to stop transmission of own device during the immediately following superframe period.

34. The congestion control method according to claim 32, wherein
the receipt response information consists of information indicative of “no reception,” “successful reception,” or “error reception,” and
in the determination step, it is determined whether the number of pieces of information of “successful reception” in the field of the receipt response information within the immediately preceding superframe period exceeds a second threshold value to determine whether to stop transmission of own device during the immediately following superframe period.

35. The congestion control method according to claim 32, wherein
the receipt response information consists of information indicative of “no reception,” “successful reception,” or “error reception,” and
in the determination step, it is determined whether the number of pieces of information of “successful reception” for a time slot used by the own node in the field of the receipt response information within the immediately preceding superframe period exceeds a third threshold value to determine whether to stop transmission of own device during the immediately following superframe period.

36. The congestion control method according to claim 32, wherein when having stopped transmission of own node in the determination step, it is determined whether to resume transmission of the own device during the immediately following superframe period based on each piece of receipt response information in the field of the receipt response information within the immediately preceding superframe period.

37. A radio communication system, in which any period within a superframe of a constant cycle is defined as an active period and rest is defined as a sleep period, and the active period is divided into plural time slots to enable each of plural radio communication devices to perform time-division two-way communication using each time slot, the system comprising:
means for allowing each of the plural radio communication devices to transmit a frame including a field of receipt response information on a frame received from another radio communication device in each of the plural time slots during each time slot period; and
means for allowing each of the plural radio communication devices that have received the frame to determine whether to stop transmission of own device during an immediately following superframe period based on each piece of receipt response information in the field of the receipt response information within an immediately preceding superframe period.

38. The radio communication system according to claim 37, wherein
the receipt response information consists of information indicative of “no reception,” “successful reception,” or “error reception,” and
the determination means determines whether the total number of pieces of information of “successful reception” and “error reception” in the field of the receipt response information within the immediately preceding superframe period exceeds a first threshold value to determine whether to stop transmission of own device during the immediately following superframe period.

39. The radio communication system according to claim 37, wherein
the receipt response information consists of information indicative of “no reception,” “successful reception,” or “error reception,” and
the determination means determines whether the number of pieces of information of “successful reception” in the field of the receipt response information within the immediately preceding superframe period exceeds a second threshold value to determine whether to stop transmission of own device during the immediately following superframe period.

40. The radio communication system according to claim 37, wherein
the receipt response information consists of information indicative of “no reception,” “successful reception,” or “error reception,” and
the determination means determines whether the number of pieces of information of “successful reception” for a time slot used by own device in the field of the receipt response information within the immediately preceding superframe period exceeds a third threshold value to determine whether to stop transmission of own device during the immediately following superframe period.

41. The radio communication system according to claim 37, wherein when having stopped transmission of the own node, the determination means determines whether to resume transmission of the own device during the immediately following superframe period based on each piece of receipt response information in the field of the receipt response information within the immediately preceding superframe period.

42. A radio communication device in a radio communication system, in which any period within a superframe of a constant cycle is defined as an active period and rest is defined as a sleep period, and the active period is divided into plural time slots to enable each of plural radio communication devices to perform time-division two-way communication using each time slot, the device comprising:
means for transmitting a frame including a field of receipt response information on a frame received from another radio communication device in each of the plural time slots during each time slot period; and
means which, when having received the frame, determines whether to stop transmission of own device during an immediately following superframe period based on each piece of receipt response information in the field of the receipt response information within an immediately preceding superframe period.

43. The radio communication device according to claim 42, wherein
the receipt response information consists of information indicative of “no reception,” “successful reception,” or “error reception,” and
the determination means determines whether the total number of pieces of information of “successful reception” and “error reception” in the field of the receipt response information within the immediately preceding superframe period exceeds a first threshold value to determine whether to stop transmission of own device during the immediately following superframe period.

44. The radio communication device according to claim 42, wherein
the receipt response information consists of information indicative of “no reception,” “successful reception,” or “error reception,” and
the determination means determines whether the number of pieces of information of “successful reception” in the field of the receipt response information within the immediately preceding superframe period exceeds a second threshold value to determine whether to stop transmission of own device during the immediately following superframe period.

45. The radio communication device according to claim 42, wherein
the receipt response information consists of information indicative of “no reception,” “successful reception,” or “error reception,” and
the determination means determines whether the number of pieces of information of “successful reception” for a time slot used by own node in the field of the receipt response information within the immediately preceding superframe period exceeds a third threshold value to determine whether to stop transmission of own device during the immediately following superframe period.

46. The radio communication device according to claim 42, wherein when having stopped transmission of own device, the determination means determines whether to resume transmission of the own device during the immediately following superframe period based on each piece of receipt response information in the field of the receipt response information within the immediately preceding superframe period.

47. The radio communication method according to claim 2, wherein when the representative node is decided, each of the plural radio communication device detects, based on the communication condition in each time slot, such a state that plural radio communication devices are congested, and transmits, during the immediately following active period, a representative node candidate declaration message declaring that the radio communication device becomes a representative node candidate, and each of plural radio communication devices that have received and transmitted the representative node candidate declaration message decides, based on a predetermined method, one of the plural radio communication devices as the representative node.

48. The radio communication method according to claim 47, wherein when the first radio communication device decided as the representative node stops transmission of the representative node advertisement message, priority of becoming a representative node candidate next time is reduced.

49. The radio communication system according to claim 6, wherein when the representative node is decided, each of the plural radio communication device detects, based on the communication condition in each time slot, such a state that plural radio communication devices are congested, and transmits, during the immediately following active period, a representative node candidate declaration message declaring that the radio communication device becomes a representative node candidate, and each of plural radio communication devices that have received and transmitted the representative node candidate declaration message decides, based on a predetermined method, one of the plural radio communication devices as the representative node.

50. The radio communication system according to claim 49, wherein when the first radio communication device decided as the representative node stops transmission of the representative node advertisement message, priority of becoming a representative node candidate next time is reduced.

51. The radio communication device according to claim 10, wherein when the representative node is decided, such a state that plural radio communication devices are congested is detected based on a communication condition in each time slot, a representative node candidate declaration message declaring that the radio communication device becomes a representative node candidate is transmitted during the immediately following active period, the representative node candidate declaration message is received, and based on a predetermined method, one of the plural radio communication devices is decided as the representative node.

52. The radio communication device according to claim 51, wherein when the radio communication device decided as the representative node stops transmission of the representative node advertisement message, priority of becoming a representative node candidate next time is reduced.

53. The radio communication method according to claim 14, wherein the radio communication device that has detected the collision transmits the collision advertisement message together with data to another time slot for transmitting the data during the current active period as well as to the predetermined time slot.

54. The radio communication method according to claim 14, wherein the collision advertisement message includes time slot identification information indicative of the time slot that has detected the collision, and
each of the plural radio communication devices that has received the collision advertisement message stops next transmission when a time slot transmitted by the radio communication device last time does not match the time slot identification information in the collision advertisement message.

55. The radio communication system according to claim 18, wherein the radio communication device that has detected the collision transmits the collision advertisement message together with data to another time slot for transmitting the data during the current active period as well as to the predetermined time slot.

56. The radio communication system according to claim 18, wherein
the collision advertisement message includes time slot identification information indicative of the time slot that has detected the collision, and
each of the plural radio communication devices that has received the collision advertisement message stops next transmission when a time slot transmitted by the radio communication device last time does not match the time slot identification information in the collision advertisement message.

57. The radio communication device according to claim 22, wherein the radio communication device that has detected the collision transmits the collision advertisement message together with data to another time slot for transmitting the data during the current active period as well as to the predetermined time slot.

58. The radio communication device according to claim 22, wherein
the collision advertisement message includes time slot identification information indicative of the time slot that has detected the collision, and
each of the plural radio communication devices that has received the collision advertisement message stops next transmission when a time slot transmitted by the radio communication device last time does not match the time slot identification information in the collision advertisement message.

59. The congestion control method according to claim 33, wherein
the receipt response information consists of information indicative of “no reception,” “successful reception,” or “error reception,” and
in the determination step, it is determined whether the number of pieces of information of “successful reception” in the field of the receipt response information within the immediately preceding superframe period exceeds a second threshold value to determine whether to stop transmission of own device during the immediately following superframe period.

60. The congestion control method according to claim 33, wherein
the receipt response information consists of information indicative of “no reception,” “successful reception,” or “error reception,” and
in the determination step, it is determined whether the number of pieces of information of “successful reception” for a time slot used by the own node in the field of the receipt response information within the immediately preceding superframe period exceeds a third threshold value to determine whether to stop transmission of own device during the immediately following superframe period.

61. The congestion control method according to claim 33, wherein when having stopped transmission of own node in the determination step, it is determined whether to resume transmission of the own device during the immediately following superframe period based on each piece of receipt response information in the field of the receipt response information within the immediately preceding superframe period.

62. The radio communication system according to claim 38, wherein
the receipt response information consists of information indicative of “no reception,” “successful reception,” or “error reception,” and
the determination means determines whether the number of pieces of information of “successful reception” in the field of the receipt response information within the immediately preceding superframe period exceeds a second threshold value to determine whether to stop transmission of own device during the immediately following superframe period.

63. The radio communication system according to claim 38, wherein
the receipt response information consists of information indicative of “no reception,” “successful reception,” or “error reception,” and
the determination means determines whether the number of pieces of information of “successful reception” for a time slot used by own device in the field of the receipt response information within the immediately preceding superframe period exceeds a third threshold value to determine whether to stop transmission of own device during the immediately following superframe period.

64. The radio communication system according to claim 38, wherein when having stopped transmission of the own node, the determination means determines whether to resume transmission of the own device during the immediately following superframe period based on each piece of receipt response information in the field of the receipt response information within the immediately preceding superframe period.

65. The radio communication device according to claim 43, wherein
the receipt response information consists of information indicative of “no reception,” “successful reception,” or “error reception,” and
the determination means determines whether the number of pieces of information of “successful reception” in the field of the receipt response information within the immediately preceding superframe period exceeds a second threshold value to determine whether to stop transmission of own device during the immediately following superframe period.

66. The radio communication device according to claim 43, wherein
the receipt response information consists of information indicative of “no reception,” “successful reception,” or “error reception,” and
the determination means determines whether the number of pieces of information of “successful reception” for a time slot used by own node in the field of the receipt response information within the immediately preceding superframe period exceeds a third threshold value to determine whether to stop transmission of own device during the immediately following superframe period.

67. The radio communication device according to claim 43, wherein when having stopped transmission of own device, the determination means determines whether to resume transmission of the own device during the immediately following superframe period based on each piece of receipt response information in the field of the receipt response information within the immediately preceding superframe period.
